(19) United States
(12) Patent Application Publication
(10) Pub. No.: US 2025/0205812 A1
(43) Pub. Date: Jun. 26, 2025

(54) LASER IRRADIATION APPARATUS, LASER IRRADIATION METHOD, LASER IRRADIATION SYSTEM, AND OBJECT

(71) Applicants: Keiichi SERIZAWA, KANAGAWA (JP); Takuei NISHIO, KANAGAWA (JP); Naoki FUKUOKA, KANAGAWA (JP); Reiko KUROMIZU, KANAGAWA (JP); Muneaki IWATA, KANAGAWA (JP); Toshishige FUJII, KANAGAWA (JP)

(72) Inventors: Keiichi SERIZAWA, KANAGAWA (JP); Takuei NISHIO, KANAGAWA (JP); Naoki FUKUOKA, KANAGAWA (JP); Reiko KUROMIZU, KANAGAWA (JP); Muneaki IWATA, KANAGAWA (JP); Toshishige FUJII, KANAGAWA (JP)

(21) Appl. No.: 18/985,019

(22) Filed: Dec. 18, 2024

(30) Foreign Application Priority Data
Dec. 22, 2023 (JP) 2023-216979

(51) Int. Cl. B23K 26/082; B23K 26/08

(52) U.S. Cl. CPC B23K 26/082; B23K 26/0853

(57) ABSTRACT

A laser irradiation apparatus includes a laser oscillator to oscillate a laser beam and irradiate, with the laser beam, an irradiation region of an object conveyed in a conveyance direction, and a scanner to scan the irradiation region with the laser beam in a main scanning direction along the conveyance direction and in a sub-scanning direction intersecting the main scanning direction. The scanner scans, with the laser beam, the irradiation region having a first size in the main scanning direction and a second size smaller than the first size in the sub-scanning direction.

### CROSS-REFERENCE TO RELATED APPLICATIONS

This patent application is based on and claims priority pursuant to 35 U.S.C. § 119 (a) to Japanese Patent Application No. 2023-216979, filed on Dec. 22, 2023, in the Japan Patent Office, the entire disclosure of which is hereby incorporated by reference herein.

### BACKGROUND

### Technical Field

Embodiments of the present disclosure relate to a laser irradiation apparatus, a laser irradiation method, a laser irradiation system, and an object.

### Related Art

Some laser irradiation apparatuses that irradiate an object such as a polyethylene terephthalate (PET) bottle with a laser beam to form an image pattern such as characters are known.

A laser scanning method used in such a laser irradiation apparatus includes a raster scanning method in which the apparatus repeatedly scans an object with the laser beam in parallel lines regardless of the shape of an image pattern, and a vector scanning method in which the apparatus scans an object with the laser beam in accordance with the shape of an image pattern.

For example, a configuration of a laser marking apparatus that uses a raster scanning method that irradiates an object to be conveyed with the laser beam is disclosed in the related art.

However, in the related art, the problem that the accuracy of laser irradiation to the object is lowered when vibration or speed fluctuation occurs in the object to be irradiated with the laser beam during conveyance has not been studied.

### SUMMARY

According to an embodiment of the present disclosure, a laser irradiation apparatus includes a laser oscillator to oscillate a laser beam and irradiate, with the laser beam, an irradiation region of an object conveyed in a conveyance direction, and a scanner to scan the irradiation region with the laser beam in a main scanning direction along the conveyance direction and in a sub-scanning direction intersecting the main scanning direction. The scanner scans, with the laser beam, the irradiation region having a first size in the main scanning direction and a second size smaller than the first size in the sub-scanning direction.

According to an embodiment of the present disclosure, a laser irradiation method includes oscillating a laser beam, irradiating, with the laser beam, an irradiation region of an object conveyed in a conveyance direction, the irradiation region having a first scanning distance in a main scanning direction along the conveyance direction and a second scanning distance in a sub-scanning direction intersecting the main scanning direction, scanning the irradiation region of the object with the laser beam in the main scanning direction, and scanning the irradiation region of the object with the laser beam in the sub-scanning direction. The second scanning distance is shorter than the first scanning distance.

According to an embodiment of the present disclosure, a laser irradiation system includes a conveyer to convey an object in a conveyance direction, and a laser irradiation apparatus including a laser oscillator to oscillate a laser beam and irradiate, with the laser beam, an irradiation region of the object conveyed in the conveyance direction, and a scanner to scan the irradiation region with the laser beam in a main scanning direction along the conveyance direction and in a sub-scanning direction intersecting the main scanning direction. The scanner scans, with the laser beam, the irradiation region having a first size in the main scanning direction and a second size smaller than the first size in the sub-scanning direction.

According to an embodiment of the present disclosure, an object includes modified portions formed by the laser irradiation method. The modified portions are arranged in the conveyance direction of the object.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a side view of a laser irradiation system according to a first embodiment of the present disclosure;

FIG. 2 is a plan view of a laser irradiation system according to the first embodiment of the present disclosure;

FIG. 3 is a block diagram illustrating a hardware configuration of a control unit according to the first embodiment of the present disclosure;

FIG. 4 is a block diagram illustrating a functional configuration of a control unit according to the first embodiment of the present disclosure;

FIGS. 5A to 5D are diagrams illustrating aspects of modified portions formed in a container by laser irradiation;

FIG. 6 is a diagram illustrating an aspect in which laser irradiation is performed on a container using a laser irradiation apparatus according to the first embodiment of the present disclosure;

FIG. 7 is a diagram illustrating the distance between a pair of modified portions formed in a container according to the first embodiment of the present disclosure;

FIG. 8A is a diagram illustrating an example in which a scanning direction is the same as a conveyance direction;

FIG. 8B is a diagram illustrating an example in which the scanning direction is opposite to the conveyance direction;

FIG. 9 is a diagram illustrating an example of a scanning path when a scanner reciprocally scans an object with a laser beam in a conveyance direction, according to the first embodiment of the present disclosure;

FIG. 10A is a diagram illustrating an irradiation region in which a size in a main scanning direction is larger than a size in a sub-scanning direction;

FIG. 10B is a diagram illustrating an irradiation region in which a size in the sub-scanning direction is larger than a size in the main scanning direction;

FIG. 11 is a diagram illustrating an example in which an irradiation region is divided into multiple irradiation regions;

FIG. 12 is a plan view of a laser irradiation system according to a second embodiment of the present disclosure;

FIG. 13 is a plan view of a laser irradiation system according to a third embodiment of the present disclosure;

FIGS. 14A to 14C are diagrams illustrating aspects in which containers having a large deviation in height are irradiated with a laser beam;

FIG. 15A is a diagram illustrating a state in which an image pattern is formed between uneven portions;

FIG. 15B is a diagram illustrating a state in which an image pattern is formed so as to overlap an uneven portion;

FIG. 16 is a plan view of a laser irradiation system according to a fourth embodiment of the present disclosure;

FIG. 17 is a diagram illustrating a state in which an image pattern is formed so as not to overlap an uneven portion;

FIGS. 18A to 18D are diagrams illustrating the order in which multiple irradiation regions are irradiated with laser beams and an airflow direction according to a fifth embodiment of the present disclosure;

FIG. 19 is a plan view of a conveyance path having a circular shape as viewed from a direction perpendicular to a plane including a conveyance path circle;

FIG. 20 is a plan view of a container on a part of the conveyance path in FIG. 19;

FIG. 21 is a graph of the relation between the distance from a best focus position in a focus range to a laser irradiation position and the beam diameter of a laser beam;

FIG. 22 is a plan view of another aspect of the conveyance of a container conveyed along the conveyance path having a circular shape;

FIG. 23 is a diagram illustrating a preferable laser emission reference position;

FIGS. 24A to 24E are diagrams illustrating examples of image patterns formed in an embodiment according of the present disclosure;

FIG. 25A is a diagram illustrating an example of an image pattern formed in an embodiment of the present disclosure;

FIG. 25B is a diagram illustrating an image pattern formed in a comparative example;

FIG. 26A is a diagram illustrating an example of an image pattern formed when vibration or speed fluctuation occurs in an embodiment of the present disclosure;

FIG. 26B is a diagram illustrating an example of an image pattern formed when vibration or speed fluctuation occurs in a comparative example;

FIG. 27 is a diagram illustrating a determination method for determining whether an image pattern is obtained in an embodiment of the present disclosure;

FIG. 28 is a diagram illustrating a determination method for determining whether an image pattern is obtained in an embodiment of the present disclosure;

FIG. 29 is a diagram illustrating a determination method for determining whether an image pattern is obtained in an embodiment of the present disclosure;

FIG. 30 is a diagram illustrating a minimum image pattern to which the determination method according to the present disclosure can be applied;

FIGS. 31A and 31B are diagrams illustrating an aspect of laser irradiation using a laser irradiation apparatus according to a comparative example;

FIG. 32A is a diagram illustrating a case where intervals between image lines are equal;

FIG. 32B is a diagram illustrating a case where intervals between the image lines are wider;

FIG. 32C is a diagram illustrating a case where intervals between the image lines are narrower; and

FIG. 33 is a graph of a relation between a fluctuation in conveyance speed and an error in an interval between image lines.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present disclosure, the accuracy of the laser irradiation to the object can be increased.

Embodiments will be described below with reference to the accompanying drawings. In the drawings, the same or like reference signs denote like elements having substantially the same or corresponding configurations, and descriptions thereof may be omitted.

### Overall Configuration of Laser Irradiation System

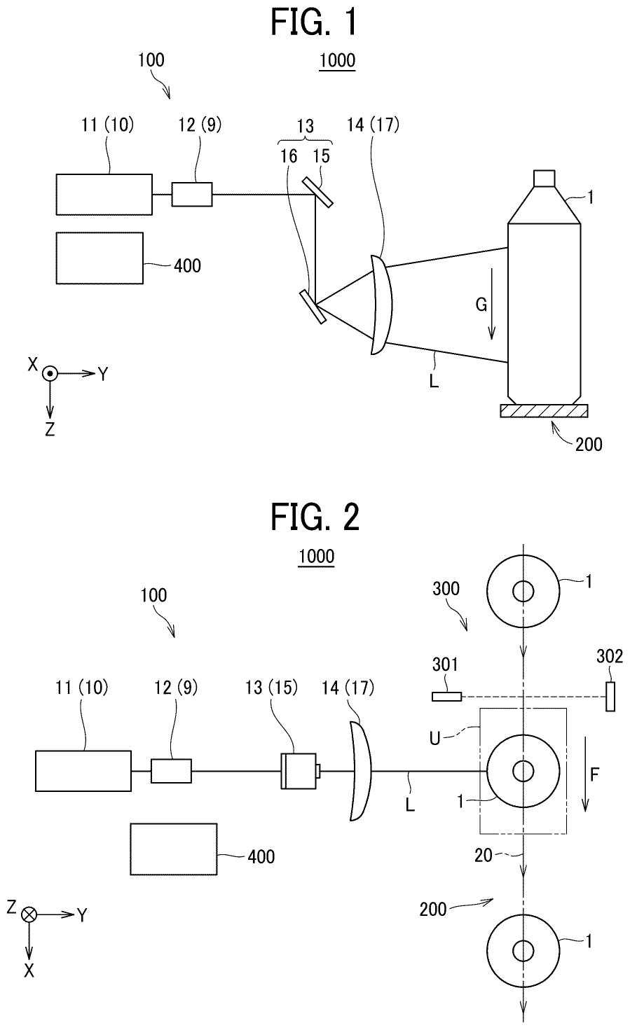

FIG. 1 is a side view of a laser irradiation system according to a first embodiment of the present disclosure, and FIG. 2 is a plan view of the laser irradiation system according to the first embodiment of the present disclosure.

As illustrated in FIG. 1, the laser irradiation system 1000 includes a laser irradiation apparatus 100, a conveyor 200, and a control unit 400. Further, in FIG. 2, the conveying position detector 300 included in the laser irradiation system 1000 is illustrated.

The laser irradiation apparatus 100 is an apparatus that irradiates an object to be conveyed by the conveyor 200 with a laser beam L. In the following description, the object to be processed is described as the container 1 made of a transparent resin such as a PET bottle, but the object to be processed is not limited to the container 1.

When the laser irradiation apparatus 100 irradiates the surface of the container 1 with the laser beam L, the properties of the surface are changed, and an image pattern is formed on the surface of the container 1. The image pattern includes a character, a code such as a barcode, a figure, or an image. For example, the image pattern includes information such as the name of the content stored in the container 1, an identification number, a manufacturer, or a manufacturing date. The surface of the container 1 on which the image pattern is formed may be the outer surface of the container 1 or the inner surface of the container 1.

The conveyor 200 is an apparatus that conveys the container 1. Examples of the conveyor 200 include a belt conveyor that conveys the container 1 at a constant speed. When the container 1 conveyed by the conveyor 200 reaches the laser irradiation area U on the conveyance path 20, the laser irradiation apparatus 100 irradiates the container 1 with the laser beam L. As a result, the properties of a position of the container 1 irradiated with the laser beam is changed, and an image pattern is formed.

The conveying position detector 300 is a device that detects a position of the container 1 upstream from the laser irradiation area U in the conveyance direction F. The conveying position detector 300 includes an optical sensor having a light emitter 301 and a light receiver 302. When the container 1 passes a position between the light emitter 301 and the light receiver 302, the light beam emitted from the light emitter 301 to the light receiver 302 is blocked by the container 1. As a result, the position of the container 1 is detected.

The control unit 400 is a computer or a device having a function equivalent to a computer that controls the operation of the entire laser irradiation system 1000 including the laser irradiation apparatus 100 and the conveyor 200. For example, the control unit 400 controls the timing of laser irradiation of the laser irradiation apparatus 100 based on the detection result of the conveying position detector 300. Specifically, when the container 1 passes a position between the light emitter 301 and the light receiver 302, a detection signal is sent from the conveying position detector 300 to the control unit 400, and the control unit 400 calculates the timing at which the container 1 enters the laser irradiation area U based on the received detection signal. The control unit 400 controls the laser irradiation apparatus 100 based on the calculated timing, and the laser irradiation apparatus 100 irradiates the container 1 with the laser beam L. As a result, an image pattern is formed on the container 1. When the container 1 is irradiated with the laser beam L, the container 1 may contain a contained object or may not contain a contained object. The type or color of the content contained in the container 1 is not limited to that of any content.

### Configuration of Laser Irradiation Apparatus

The configuration of the laser irradiation apparatus according to the first embodiment of the present disclosure will be described with reference to FIGS. 1 and 2.

The laser irradiation apparatus 100 includes a laser oscillator 11, an optical system 12, a scanner 13, and a light condenser 14.

As the laser oscillator 11, for example, a pulse laser oscillator or continuous-wave (CW) laser oscillator may be used. In the following description, a pulse laser oscillator 10 is used as the laser oscillator 11.

The pulse laser oscillator 10 oscillates a substantially parallel pulse-like laser beam. The pulse laser oscillator 10 is configured to switch oscillation (ON) and non-oscillation (OFF) based on data of an image pattern formed in the container 1. For example, the pulse laser oscillator 10 can switch three oscillation waves: a fundamental wave having an oscillation wavelength of 1064 nanometers (nm); a second harmonic wave having an oscillation wavelength of 532 nm; and a third harmonic wave having an oscillation wavelength of 355 nm. For example, a pulse laser oscillator of Talisker Ultra355-4 manufactured by Coherent Corp. based on a fiber laser can be applied. The laser beam has a pulse width of 15 picoseconds (ps) or less at any oscillation wavelength. The repetition frequency of the laser beam can be preferably selected in a range from a single shot to 200 kilohertz (kHz). The laser beam has a beam diameter of approximately 2.0 millimeters (mm) for the fundamental wave, approximately 1.4 mm for the second harmonic wave, and approximately 1.3 mm for the third harmonic wave.

The optical system 12 has a function to adjust the beam diameter of the laser beam L oscillated from the pulse laser oscillator 10. In the first embodiment of the present disclosure, the optical system 12 includes a beam expander 9. The beam expander 9 magnifies the beam diameter of the laser beam L oscillated from the pulse laser oscillator 10 at a predetermined magnification ratio and emits the laser beam L as a substantially parallel laser beam.

The scanner 13 is a device that deflects the laser beam L having a beam diameter adjusted by the optical system 12 and scans an object with the laser beam L. In the first embodiment of the present disclosure, a galvano scanner including a first galvano mirror 15 and a second galvano mirror 16 is used as an example of the scanner 13. Either one of the first and second galvano mirrors 15 and 16 may be a polygon mirror. The first galvano mirror 15 is disposed upstream from the second galvano mirror 16 in the optical axis direction, and deflects the laser beam L having a beam diameter adjusted by the optical system 12 toward the second galvano mirror 16. The second galvano mirror 16 deflects the laser beam L deflected by the first galvano mirror 15 toward the light condenser 14. As a result, the scanner 13 scans the container 1 with the laser beam L in two directions, i.e., a direction along the conveyance direction F of the container 1 (see FIG. 2) and a direction G (see FIG. 1) intersecting the direction along the conveyance direction F.

The light condenser 14 is a member that condenses the laser beam L deflected by the scanner 13. In the first embodiment of the present disclosure, the light condenser 14 includes, for example, an fe lens 17. The fe lens 17 is a lens designed and manufactured such that the scanning speed of the laser beam L passing through the circumference and the scanning speed of the laser beam L passing through the center are substantially constant. When the laser beam L deflected by the scanner 13 enters the f lens 17, the laser beam L is condensed by the fθ lens 17, and the surface of the container 1 is irradiated with the laser beam L. The fo lens 17 may include one lens or be a combination of multiple lenses. The function of the fθ lens 17 may be implemented by a configuration including an optical element such as a mirror other than a lens.

### Configuration of Control Unit

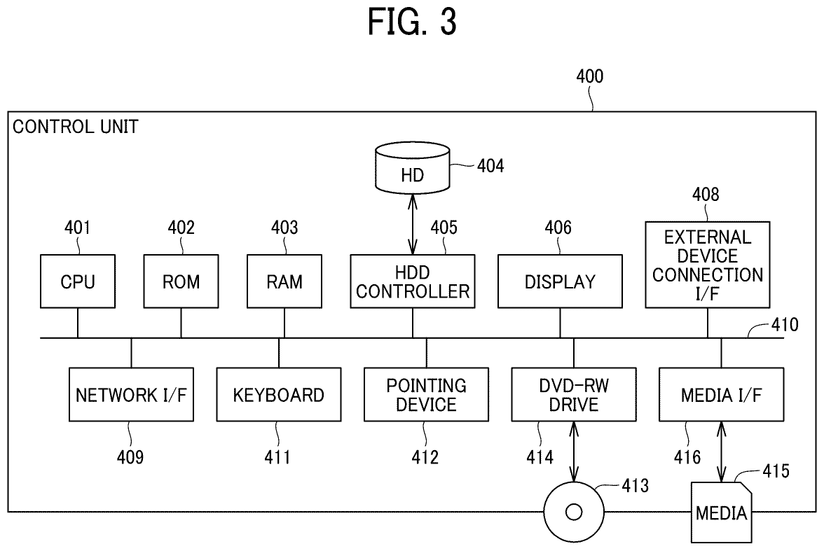

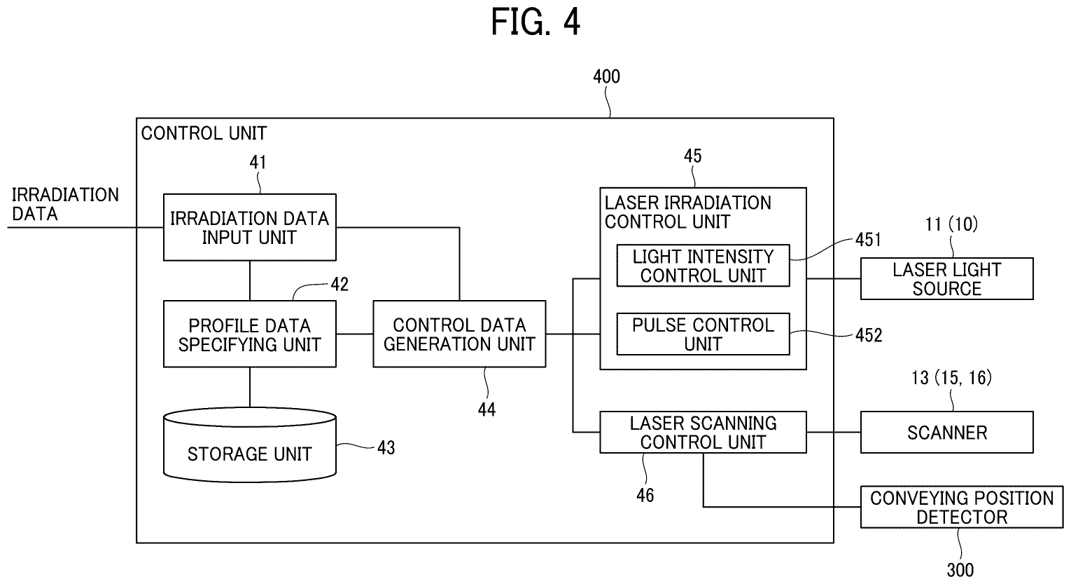

The configuration of the control unit according to the first embodiment of the present disclosure will be described with reference to FIGS. 3 and 4. FIG. 3 is a block diagram illustrating a hardware configuration of a control unit according to the first embodiment of the present disclosure. FIG. 4 is a block diagram illustrating a functional configuration of a control unit according to the first embodiment of the present disclosure.

As illustrated in FIG. 3, the control unit 400 includes a central processing unit (CPU) 401, a read-only memory (ROM) 402, a random-access memory (RAM) 403, a hard disk (HD) 404, and a hard disk drive (HDD) controller 405, and a display 406. The control unit 400 includes an external device connection interface (I/F) 408, a network I/F 409, a bus line 410, a keyboard 411, a pointing device 412, a digital versatile disk rewritable (DVD-RW) drive 414, and a media I/F 416.

The CPU 401 is a processor and controls the overall operation of the control unit 400. The ROM 402 is a memory that stores a program used for driving the CPU 401 such as an initial program loader (IPL).

The RAM 403 is a memory used as a work area of the CPU 401. The HD 404 is a memory that stores various data such as programs. The HDD controller 405 controls reading or writing of various data from or to the HD 404 under the control of the CPU 401.

The display 406 displays various information such as a cursor, a menu, a window, characters, or images. The external device connection interface (I/F) 408 is an interface for connecting various external devices. In this case, the external devices include the laser oscillator11 (pulse laser oscillator 10), the scanner 13 (galvano mirrors 15, 16), and the conveying position detector 300. Further, a universal serial bus (USB) memory, or a printer can also be connected.

The network I/F 409 is an interface for data communication using a communication network. The bus line 410 is an address bus or a data bus for electrically connecting each component such as the CPU 401.

The keyboard 411 is an input device including multiple keys for inputting characters, numerical values, or various instructions. The pointing device 412 is an input device for selecting and executing various instructions, selecting a processing object, or moving a cursor.

The DVD-RW drive 414 controls reading or writing of various data to or from the DVD-RW 413 serving as a removable recording medium. However, the recording medium is not limited to the DVD-RW. The media I/F 416 controls the media 415 such as a flash memory to read or write (store) data.

The control unit 400 may not include all the hardware components. Depending on the mode of using the laser irradiation apparatus 100, there may be hardware that is not included. Further, the laser irradiation apparatus 100 may include all of the hardware and functional configuration of the control unit 400, or some of the hardware and functional configuration may be connected to the outside of the laser irradiation apparatus 100.

As illustrated in FIG. 4, the control unit 400 includes an irradiation data input unit 41, a profile data specifying unit 42, a storage unit 43, a control data generation unit 44, a laser irradiation control unit 45, and a laser scanning control unit 46.

Since the CPU 401 executes a predetermined program and outputs a control signal via the external device connection I/F 408, each function of the control data generating unit 44, the laser irradiation control unit 45, and the laser scanning control unit 46 is implemented. An electronic circuit or an electric circuit such as an application-specific integrated circuit (ASIC) or a field-programmable gate array (FPGA) may be added to the hardware configuration of the control unit 400, and the electronic circuit or the electric circuit may implement a part or all of the functions of each component. The function of the storage unit 43 is implemented by the HD 404.

The irradiation data input unit 41 receives irradiation data of the laser beam L with which the laser irradiation apparatus 100 irradiates the container 1. The irradiation data is input by a user using the keyboard 411 or the pointing device 412 of the control unit 400. The irradiation data includes data relating to the image pattern formed on the container 1 and other data necessary for laser irradiation. The irradiation data may also be recorded in an external device such as a personal computer (PC) or a scanner.

The irradiation data input unit 41 outputs the input irradiation data to the control data generation unit 44 and the profile data specifying unit 42. The irradiation data input from the irradiation data input unit 41 may be temporarily stored in the storage unit 43. In such a case, the irradiation data corresponding to the shape or type of the container 1 may be stored in the storage unit 43 in advance.

The profile data specifying unit 42 specifies the profile data from the storage unit 43. The profile data is data that determines an irradiation region and a non-irradiation region when the container is irradiated with the laser beam. The profile data is also data that determines an acceleration, a period of acceleration or deceleration, and a period of constant speed when the operation speed of the laser irradiation apparatus 100 is accelerated.

The profile data is stored in the storage unit 43. The process of storing the profile data may be performed in advance or may be temporarily performed when the scanning and the irradiation of the laser beam L are performed.

The control data generation unit 44 generates control data based on the irradiation data from the irradiation data input unit 41 and the profile data of the profile data specifying unit 42. The control data is data that controls the laser irradiation apparatus 100. Specifically, the control data includes data that controls the laser oscillator 11 and the scanner 13.

The control data generation unit 44 outputs the generated control data to the laser irradiation control unit 45 and the laser scanning control unit 46.

The laser irradiation control unit 45 controls the irradiation of the laser beam L oscillated from the laser oscillator 11 based on the control data. The laser scanning control unit 46 controls the scanner 13 based on the detected information detected by the conveying position detector 300.

When the laser oscillator 11 includes multiple pulse laser oscillators 10, the laser irradiation control unit 45 independently controls each of the multiple pulse laser oscillators 10.

The laser irradiation control unit 45 further includes a light intensity control unit 451 and a pulse control unit 452. The light intensity control unit 451 controls the light intensity of the laser beam L. The pulse control unit 452 controls the pulse width and the irradiation timing of the laser beam L.

The laser scanning control unit 46 controls the deflection of the laser beam L by the scanner 13 based on the control condition data. Specifically, the laser scanning control unit 46 controls the ON-and-OFF operation of the first galvano mirror 15 and the second galvano mirror 16.

### Changes in Properties of Object

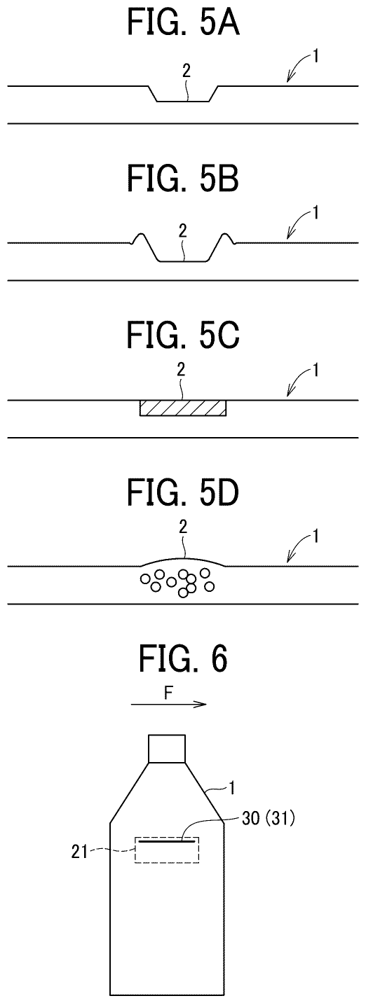

FIGS. 5A to 5D are diagrams illustrating aspects of modified portions formed on the container 1 by laser irradiation.

When the laser irradiation apparatus 100 irradiates the surface of the container 1 with the laser beam L, the properties of the surface of the container 1 are changed, and a modified portion 2 is formed. FIG. 5A is a diagram illustrating an aspect of a modified portion 2 having a recess formed by evaporation of the surface of the container 1 caused by the irradiation with the laser beam L. FIG. 5B is a diagram illustrating an aspect of a modified portion 2 in the case where the surface of the container 1 is melted. In the case of FIG. 5B, the circumferential edge of the modified portion 2 having a recess is raised as compared with FIG. 5A. FIG. 5C is a diagram illustrating an aspect of a modified portion 2 in which the surface of the container 1 is crystallized. FIG. 5D is a diagram illustrating an aspect of a modified portion 2 in which a part of the container 1 is foamed. Each modified portion 2 has a surface roughness larger than the non-laser-irradiated portion on the container 1 so that the light diffusivity is enhanced and the visibility is increased. As a result, an image pattern that can be visually recognized is formed on the surface of the container 1.

In order to form the modified portion 2 due to evaporation, it is preferable to use a pulse laser oscillator 10 having a wavelength of 355 nm or more and 1064 nm or less, and a pulse width of 10 femtoseconds (fs) or more and 500 nanoseconds (ns) or less as the laser oscillator 11. When a CW laser oscillator having a wavelength of 355 nm or more to 1064 nm or less is used as the laser oscillator 11, the modified portion 2 due to melting can be formed. Further, when the irradiation of the laser beam L is continued even after the melting, the surface or a portion below the surface of the container 1 is foamed, and a whitened modified portion 2 can be formed. In order to form a crystallized modified portion 2, it is preferable to irradiate the container 1 made of PET with a CW laser beam having a wavelength of 355 nm or more and 1064 nm or less to rapidly increase the temperature of the laser-irradiated portion of the container 1. After the temperature of the laser-irradiated portion is increased, the temperature of the laser-irradiated portion is gradually decreased while the power of the laser beam L is decreased. As a result, the whitened modified portion 2 due to crystallization is obtained. However, if the laser irradiation of the laser beam L is suddenly stopped after the temperature of the laser-irradiated portion is increased, the temperature of the laser-irradiated portion is rapidly decreased. As a result, the laser-irradiated portion becomes transparent and amorphous, and the whitened modified portion 2 cannot be obtained.

In addition to the formation of the whitened modified portion 2, the modified portion 2 may be formed by yellowing a portion of the surface of the container 1 or changing the properties by an oxidation reaction or surface modification. Further, the surface of the container 1 is coated with an absorber (e.g., a conversion material) to convert light energy into thermal energy in advance, and the modified portion 2 having an uneven portion is formed on the surface of the container 1 by the thermal energy converted at a time when the surface of the container 1 is irradiated with the laser beam L.

The size, shape, or depth of the modified portion 2 can be changed by adjusting the light energy, the size, or the irradiation time of the laser beam L with which the laser oscillator 11 irradiates the container 1. Although an intensity distribution of the laser beam L in a cross section is typically a Gaussian distribution, the intensity distribution can be changed by combining laser beams from an array light source, or a top-hat-shaped intensity distribution having a flat central intensity distribution can be made by designing an irradiation optical system. Further, it is preferable that the irradiation size of the laser beam L be adjusted by the laser oscillator 11 and the optical system 12, and that the irradiation size of the laser beam be substantially constant in laser processing. The term “constant” indicates that there is substantially no fluctuation within a tolerance of the processing accuracy, and may include fluctuation within the tolerance of about several percent depending on the processing accuracy.

### Problem of Laser Beam Irradiation

The problem in the case of laser irradiation to the container while the container is conveying will be described.

FIGS. 31A and 31B are diagrams illustrating an aspect of laser irradiation using a laser irradiation apparatus according to a comparative example different from an embodiment of the present disclosure.

In the comparative example, as illustrated in FIG. 31A, when the container 1 is conveyed and the irradiation region 21 of the container 1 reaches the laser irradiation position E, the irradiation region 21 is irradiated with the laser beam to form one image line 30a. In this case, since the scanning direction of the laser beam is perpendicular to the conveyance direction F of the container 1, the image line 30a is formed in a longitudinal direction. The term “irradiation region” is a region in which the image pattern 31 is formed and is a region that matches the shape of the image pattern 31. Thus, the “irradiation region” is not a region partitioned by a visible line, but may be a conceptually partitioned region. The “irradiation region” in the following description also indicates the same region.

As illustrated in FIG. 31B, when the container 1 is conveyed and the irradiation region 21 of the container 1 is shifted from the laser irradiation position E by one line (i.e., the width of one image line) in the conveyance direction F, the laser irradiation apparatus scans the laser irradiation region again with the laser beam in the longitudinal direction (intersecting or perpendicular to the conveyance direction F) to irradiate. Accordingly, an image line 30b is newly formed adjacent to the image line 30a formed before In the following process, in the same manner, the laser irradiation apparatus scans the irradiation region 21 with the laser beam in accordance with the conveyance of the container 1.

As described above, a two-dimensional image pattern is formed by a combination of the one-dimensional scanning of the laser beam in the longitudinal direction and the conveyance of the container 1 in the transverse direction. However, in such a laser irradiation method, there is a problem that the interval between adjacent image lines changes when the conveyance speed fluctuates or vibration in the conveyance direction occurs while the container 1 is irradiated with the laser beam L.

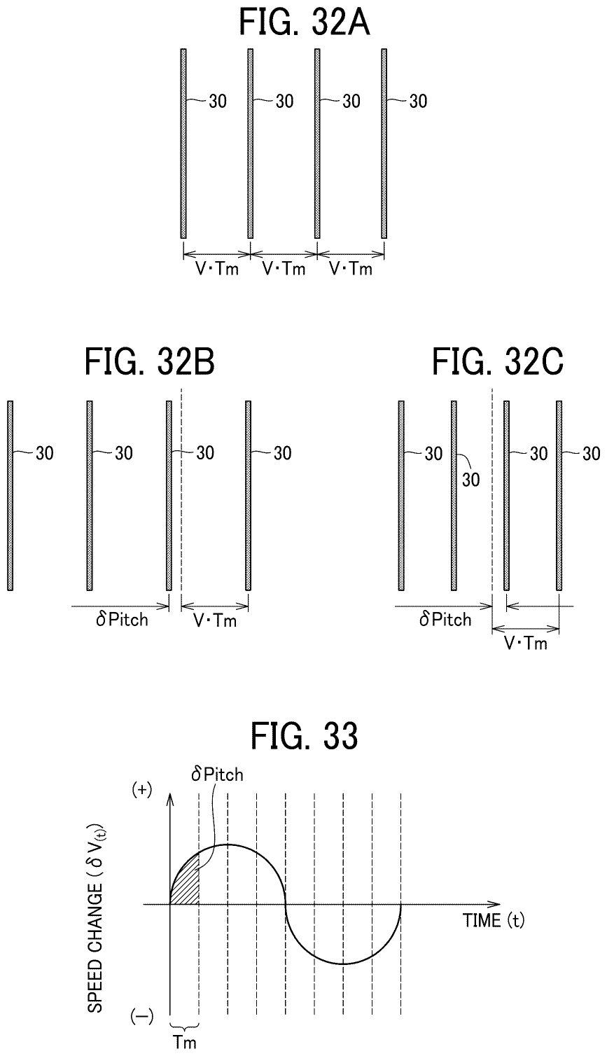

In other words, when the container 1 conveyed at the constant conveyance speed V mm/second(s) is scanned with the laser beam at the scanning line period Tm s to irradiate, as illustrated in FIG. 32A, the image lines 30 are formed at the same intervals V·Tm mm. However, when the conveyance speed fluctuation or the vibration in the conveyance direction occurs, the intervals between the image lines 30 become larger or smaller than V·Tm mm as illustrated in FIGS. 32B and 32C. At this time, when the speed fluctuation SV (t) of the conveyance speed changes as illustrated in FIG. 33, the error δ Pitch of the interval between the image lines 30 at each scanning line period Tm is expressed by the following expression (1).

$$δPitch = {\int }_{( N - 1 ) \cdot Tm}^{N \cdot Tm} δ {V}_{( t )} dt \qquad Expression ( 1 )$$

In FIG. 33, when the fluctuation of the conveyance speed is (+), the interval between the image lines 30 becomes larger by the error δ Pitch as illustrated in FIG. 32B. In contrast, when the fluctuation of the conveyance speed is (−), the interval between the image lines 30 becomes smaller by the error δ Pitch as illustrated in FIG. 32C. The error δ Pitch of the interval between the image lines 30 may occur not only when the conveyance speed fluctuation occurs but also when vibration in the conveyance direction occurs with respect to the container 1.

As described above, in the comparative example, when the conveying speed fluctuation occurs or the vibration occurs, the interval between the image lines 30 varies, and there is a problem that the laser irradiation accuracy with respect to the container 1 is decreased. Further, when the interval between the adjacent image lines 30 varies, a dense portion and a sparse portion are generated in the image lines 30. As a result, this is recognized as density unevenness of the image pattern.

In order to increase the accuracy of laser irradiation to the container 1, the laser irradiation apparatus, laser irradiation system, and laser irradiation method described below are proposed in the present disclosure. The characteristics of the present disclosure will be described below with reference to the first embodiment of the present disclosure.

### Characteristics of the Present Disclosure

FIG. 6 is a diagram illustrating an aspect in which laser irradiation is performed on a container using the laser irradiation apparatus according to the first embodiment of the present disclosure.

As illustrated in FIG. 6, in the first embodiment of the present disclosure, the scanning direction of the laser beam is different from the direction of the comparative example (see FIGS. 31A and 31B). In other words, in the first embodiment of the present disclosure, the image line 30 (image pattern 31) is formed in a direction along the conveyance direction F of the container 1 so as to be the scanning direction of the laser beam.

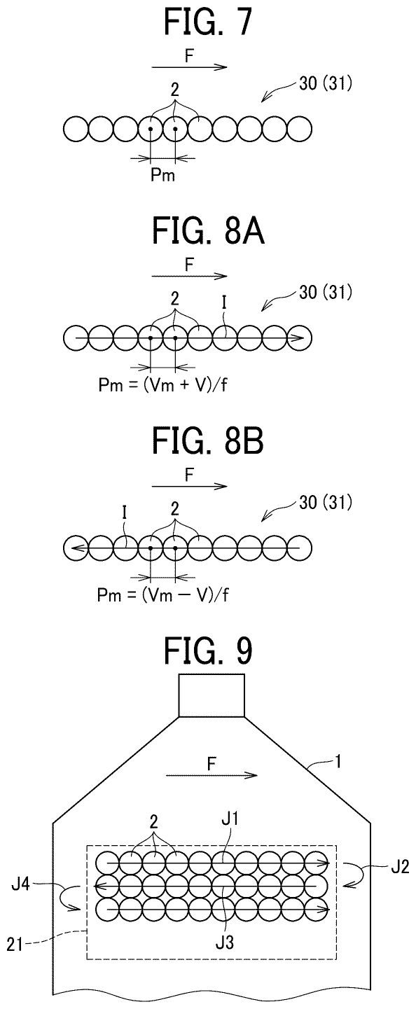

In the first embodiment of the present disclosure, since the pulse laser oscillator 10 is used as the laser oscillator 11, and the scanner 13 scans the irradiation region with a laser beam in a direction along the conveyance direction F, as illustrated in FIG. 7, an image line 30 (image pattern 31) in which the minute modified portions 2 are arranged in a row along the conveyance direction F is formed. At this time, even if the conveyance speed fluctuation of the container 1 occurs or the vibration in the conveyance direction occurs, since the laser scanning direction is along the conveyance direction F, the irradiation accuracy of the laser beam is less affected by the conveyance speed fluctuation or the vibration. Accordingly, the interval Pm between the adjacent modified portions 2 can be prevented from varying, and the length of the entire image line 30 can be also prevented from varying.

For example, in the comparative example, when it is desired to form the multiple image lines 30 at intervals of 100 micrometers (μm), if the speed fluctuation occurs or the vibration of the container 1 occurs during laser irradiation, an error & Pitch of about 50 μm occurs in the intervals between the image lines 30. In this case, the interval between the image lines 30 is shifted by 50% from the original interval of 100 μm. In contrast, in the first embodiment of the present disclosure, when the image lines 30 are formed so as to have a length of 50 millimeters (mm), the variation in length of each image line 30 is 50 μm, and the ratio of the variation to the total length of the image lines 30 is 0.1% (i.e., 50 μm/50 mm×100=0.1%). As described above, in the first embodiment of the present disclosure, since the image pattern is less affected by the influence of the speed fluctuation or the vibration than the comparative example, the image pattern can be formed with high accuracy, and the quality of the image pattern can be increased.

The scanning direction I of the laser beam may be the same as the conveyance direction F as illustrated in FIG. 8A, or opposite to the conveyance direction F as illustrated in FIG. 8B. The scanning direction I is not necessarily parallel to the conveyance direction F, but may be rather inclined to the conveyance direction F. Specifically, the effect of the present disclosure can be obtained even when the scanning direction I is inclined by ±10° with respect to the conveyance direction F. In other words, in the present disclosure, the aspect in which “the laser irradiation apparatus scans an object with the laser beam in the direction along the conveyance direction” includes not only a case where the scanning direction I is the same direction as the conveyance direction F and a case where the scanning direction I is opposite to the conveyance direction F, but also a case where the scanning direction I is parallel to the conveyance direction F and is inclined by ±10° with respect to the conveyance direction F.

As described above, in the present disclosure, the scanning direction I may be a direction along the conveyance direction F, but when the scanner reciprocally scans the laser beam along the conveyance direction F, the interval Pm between the adjacent modified portions 2 may be different in the forward path and the backward path. In other words, as illustrated in FIG. 8A, when the scanning direction I is the same as the conveyance direction F, the interval Pm between the adjacent modified portions 2 is Pm=(Vm+V)/f, where V (meter per second (m/s)) is the conveyance speed, Vm (m/s) is the scanning speed, and f (hertz (Hz)) is the frequency. However, as illustrated in FIG. 8B, when the scanning direction I is the opposite direction of the conveyance direction F, the interval Pm between the adjacent modified portions 2 is Pm=(Vm−V)/f, where V (m/s) is the conveyance speed, Vm (m/s) is the scanning speed, and f (Hz) is the frequency. As described above, even if the scanning speed V and the frequency f of the laser beam are the same, the interval Pm between the adjacent modified portions 2 differs depending on whether the scanning direction I is the same as or opposite to the conveyance direction F. Accordingly, when the scanner reciprocally scans an object with the laser beam along the conveyance direction F, it is preferable to set the scanning speed or frequency of the laser irradiation such that the interval Pm between the adjacent modified portions 2 in the forward path and the backward path is equal (Pm=(Vm+V)/f=(Vm−V)/f). Accordingly, the interval Pm between the modified portions 2 can be prevented from varying, and the quality of the image pattern can be increased.

### Example of Scanning Path

FIG. 9 is a diagram illustrating an example of a scanning path when a scanner reciprocally scans a laser irradiation region of an object with a laser beam along a conveyance direction F, according to a first embodiment of the present disclosure.

In the case of FIG. 9, the laser irradiation apparatus 100 scans the irradiation region 21 of the container 1 with the laser beam in the direction indicated by the arrow J1 that is the same as the conveyance direction F at a constant speed to irradiate. When the laser beam reaches one end of the irradiation region 21, the apparatus reverses the scanning of the laser beam in the direction indicated by the arrow J2 in a region outside of the irradiation region 21. At this time, since the scanning speed is decelerated and accelerated, the reverse scanning is performed such that the following scanning speed becomes constant. The scanner scans the irradiation region 21 with the laser beam in the opposite direction indicated by the arrow J3 to the conveyance direction F at a constant speed to irradiate. When the laser beam reaches the other end of the irradiation region 21, the apparatus reverses the scanning of the laser beam in the direction indicated by the arrow J4 in a region outside of the irradiation region 21 same as the previous reverse scanning. In the following scanning, since the reciprocal scanning of the laser beam is repeated in the same manner, the irradiation region 21 is sequentially scanned with the laser beam from the top to the bottom to form an image pattern.

As described above, in the present embodiment, the two-dimensional image pattern can be formed by repeatedly performing the laser scanning in a direction intersecting the conveyance direction F. Among two scanning directions intersecting each other, a direction having a longer scanning length in a single scanning is a main scanning direction, and the other direction intersecting the main scanning direction is a sub-scanning direction. Thus, in the present disclosure, the main scanning direction is a direction along the conveyance direction F. As a result, laser irradiation with high accuracy can be performed because the laser irradiation is less affected by speed fluctuation or vibration.

### Productivity of Image Pattern

The productivity of the image pattern will be described below.

Even in the case where image patterns having the same area are formed on the containers, the shorter the time required for forming the image pattern in a single container, the higher the productivity. The time ta(s) required for forming an image pattern on a single container is expressed by the following expression (2).

$$ta = ( Ls / vs + tr ) * Lf / 25.4 * rf , \qquad Expression ( 2 )$$

where “vs” is the scanning speed of the laser beam in the main scanning direction in the irradiation region 21 (m/s), “rf” is the resolution of the image pattern in the sub-scanning direction (i.e., variation in the distance between the modified portions 2 in the direction intersecting the conveyance direction F) (dot per inch (dpi)), “tr” is the time required for the reverse scanning(s), “Ls” is the size of the irradiation region or the image pattern in the main scanning direction (m), and “Lf” is the size of the irradiation region or the image pattern in the sub-scanning direction (m).

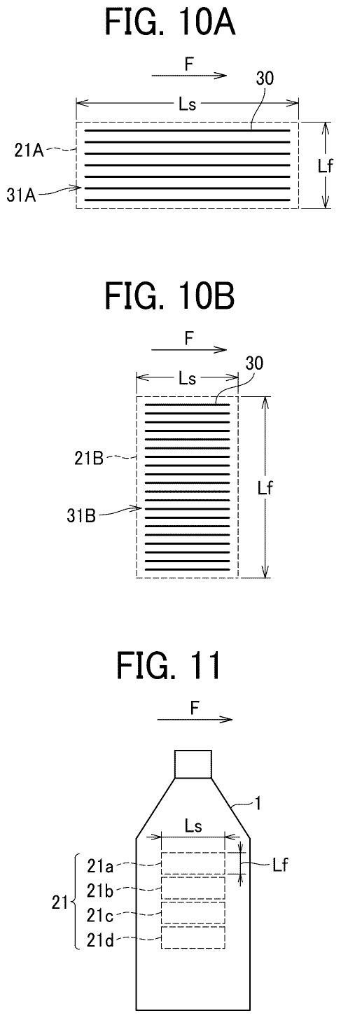

The time required for forming the image patterns 31A (FIG. 10A) and 31B (FIG. 10B), that is, the productivity, is different between the case of the irradiation region 21A in which the size Ls in the main scanning direction is larger than the size Lf in the sub-scanning direction as illustrated in FIG. 10A, and the case of the irradiation region 21B in which the size Lf in the sub-scanning direction is larger than the size Ls in the main scanning direction as illustrated in FIG. 10B, even if the image area is the same. For example, when each time ta(s) required for forming the image patterns 31A and 31B is calculated by using the above expression (2), assuming that the size Ls of the irradiation region 21A in the main scanning direction is 50.8 mm and the size Lf in the sub-scanning direction is 25.4 mm in FIG. 10A, and the size Ls of the irradiation region 21B in the main scanning direction is 25.4 mm and the size Lf in the sub-scanning direction is 50.8 mm in FIG. 10B, the time ta(s) in the case of FIG. 10A is 0.20, while the time ta(s) in the case of FIG. 10B is 0.30.

As described above, even in the case where the image patterns 31A and 31B are formed in the irradiation regions 21A and 21B having the same area (i.e., 50.8 [mm]×25.4 [mm]=1290 [mm²]), when the laser irradiation is performed in the main scanning direction along the conveyance direction F, the time ta required for forming the image pattern in the irradiation region 21A having the larger size Ls in the main scanning direction is shorter than the image pattern in the irradiation region 21B having the large size Lf in the sub-scanning direction. This is because the time required for forming the image pattern is shortened as the number of times of reverse scanning of the laser beam is decreased when the size Ls in the main scanning direction is larger.

From the above, the present disclosure proposes a laser irradiation apparatus, a laser irradiation system, and a laser irradiation method that scan an irradiation region 21A having a size Ls in the main scanning direction equal to or larger than the size Lf in the sub-scanning direction with a laser beam in the main scanning direction along the conveyance direction F. Accordingly, the accuracy of laser irradiation on the container during conveyance can be increased and the productivity can also be increased.

Other embodiments of the present disclosure will be described. In the following description, the parts different from those of the first embodiment of the present disclosure will be mainly described, and the description of the same parts will be appropriately omitted.

### Second Embodiment

As described above, in the first embodiment of the present disclosure, in order to increase productivity, one of the characteristics is that the irradiation region having the size in the main scanning direction is equal to or larger than the size in the sub-scanning direction is irradiated with the laser beam. However, depending on the design of the image pattern, the image pattern 31B having a larger size in the sub-scanning direction illustrated in FIG. 10B may be required.

In the second embodiment of the present disclosure, even when the image pattern 31B having a larger size in the sub-scanning direction is required, in order to increase productivity, the irradiation region 21 is divided into multiple irradiation regions 21a to 21d in the sub-scanning direction (i.e., the vertical direction or longitudinal direction in the drawing) as illustrated in FIG. 11, and each of the irradiation regions 21a to 21d is individually irradiated with the laser beam. As described above, the irradiation region 21 is divided into the multiple irradiation regions 21a to 21d so that the size Lf of each of the irradiation regions 21a to 21d in the sub-scanning direction can be decreased. Accordingly, the laser irradiation time for each of the irradiation regions 21a to 21d can be decreased.

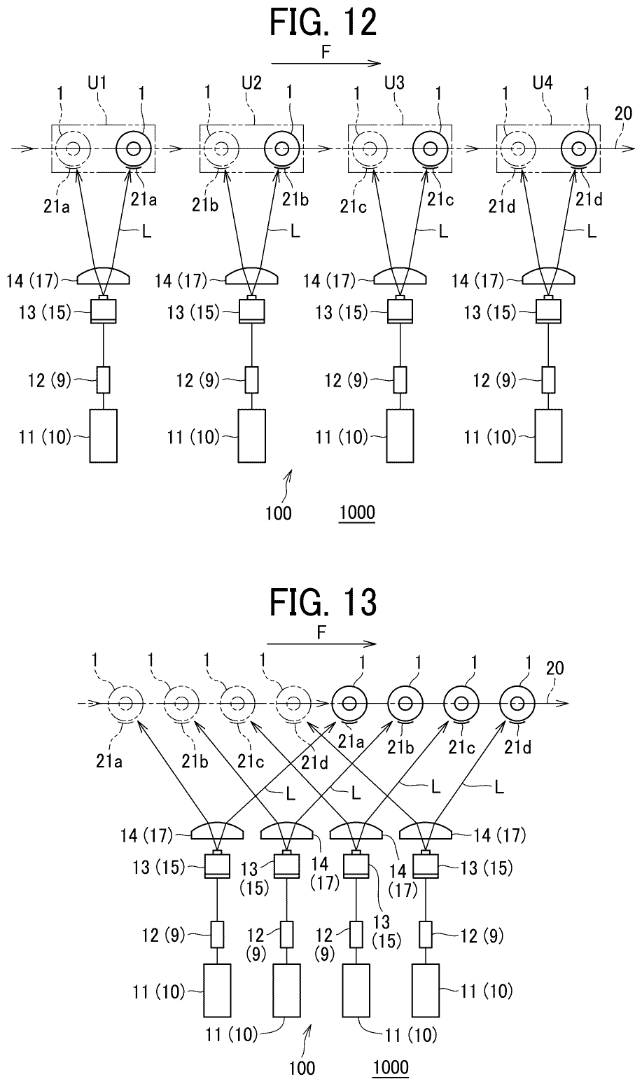

FIG. 12 is a plan view of a laser irradiation system according to a second embodiment of the present disclosure.

As illustrated in FIG. 12, in the laser irradiation system 1000 according to the second embodiment of the present disclosure, the laser irradiation apparatus 100 includes multiple scanners 13. The laser irradiation system 1000 also includes multiple laser oscillators 11, multiple optical systems 12, and multiple light condensers 14 in correspondence with the number of the multiple scanners 13. Although the first galvano mirrors 15 are only illustrated as the multiple scanners 13, each of the multiple scanners 13 is configured to perform two-dimensional scanning of a laser beam using two galvano mirrors.

In the second embodiment according to the present disclosure, when the container 1 is conveyed from left to right in FIG. 12, the container 1 passes through the multiple laser irradiation areas U1 to U4 in order. When the container 1 reaches the first laser irradiation area U1, the irradiation region 21a of the container 1 is irradiated with the laser beam L. When the container 1 reaches the second laser irradiation area U2, the irradiation region 21b of the container 1 is irradiated with the laser beam L. In the same manner, the container 1 reaches the third laser irradiation area U3 and the fourth laser irradiation area U4, the irradiation regions 21c and 21d are irradiated with the laser beam L, individually.

As described above, in the case of the second embodiment according to the present disclosure, since multiple irradiation regions 21a to 21d are individually irradiated with the laser beam L, even if the laser irradiation apparatus scans the irradiation regions with the laser beam L in the main scanning direction along the conveyance direction F, the laser irradiation time in each of the irradiation regions 21a to 21d can be shortened. As a result, the productivity is increased.

As described above, in the second embodiment according to the present disclosure, even if the image pattern 31B is larger in the sub-scanning direction, since the irradiation region 21 is divided into multiple irradiation regions 21a to 21d in the sub-scanning direction, and each of the multiple irradiation regions 21a to 21d is individually irradiated with the laser beam, the image pattern can be formed in a shorter time, and the productivity can be increased.

The order of laser irradiation for the irradiation regions 21a to 21d may start from the highest irradiation region 21a or from the lowest irradiation region 21d illustrated in FIG. 11. The number of the irradiation regions to be divided may be two, three, or five or more, in addition to four as illustrated in FIG. 11.

### Third Embodiment

FIG. 13 is a plan view of a laser irradiation system according to a third embodiment of the present disclosure.

In the third embodiment according to the present disclosure, the scanning ranges of the multiple scanners 13 in the second embodiment are set to overlap each other.

In this case, as in the second embodiment according to the present disclosure, since the multiple irradiation regions 21a to 21d divided in the sub-scanning direction are individually irradiated with the laser beams, the productivity can be increased. Further, in this case, the space for installing the laser irradiation apparatus 100 can be reduced. In addition, the time required for forming the image pattern can be shortened.

### Fourth Embodiment

A fourth embodiment according to the present disclosure will be described.

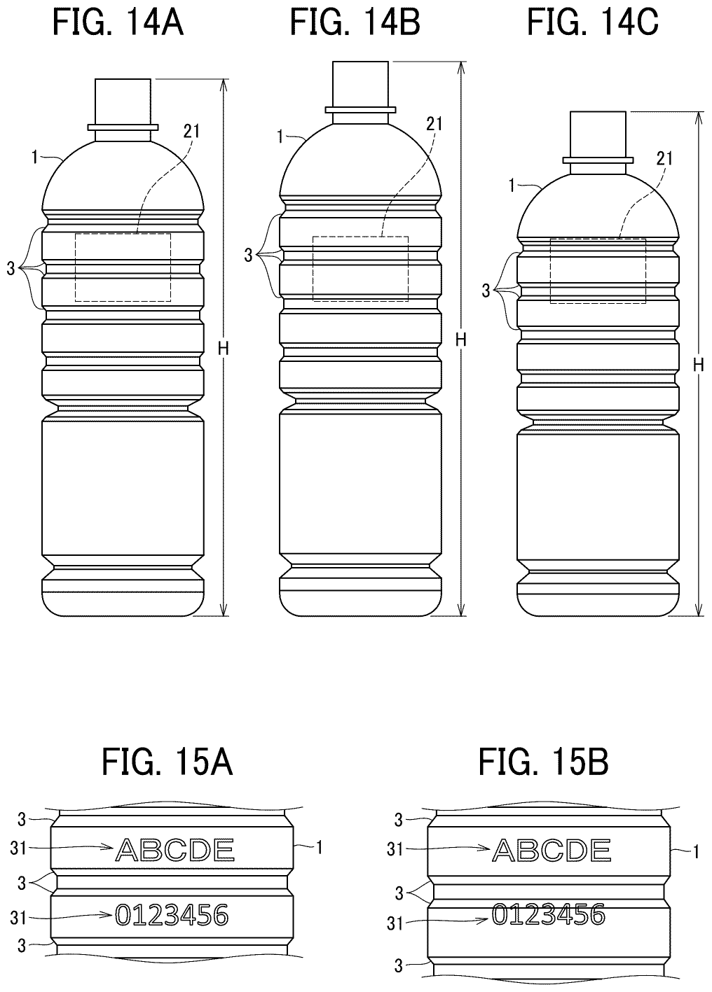

In a container such as a PET bottle having an uneven portion on the surface, if an image pattern is formed on the uneven portion of the container, the visibility of the image pattern is lowered or the image pattern is difficult to be discriminated. For this reason, it is preferable to form the image pattern avoiding the uneven portion. However, as illustrated in FIGS. 14A to 14C, the height dimension H varies greatly depending on the container 1. In this case, since the positions of the uneven portions 3 vary with variations in the height dimensions H of the containers 1, the relative positions of the irradiation regions 21 with respect to the uneven portions 3 are different even if the irradiation regions 21 are set at the same height. As a result, although the image pattern 31 should be formed between the uneven portions 3 as illustrated in FIG. 15A (see the image pattern 31 of “numbers” on the lower side of FIG. 15B), the image pattern 31 may be formed so as to overlap the uneven portion 3 as illustrated in FIG. 15B.

In the fourth embodiment according to the present disclosure, the following configuration is used in order to prevent the image pattern 31 from overlapping the uneven portion 3 of the container 1.

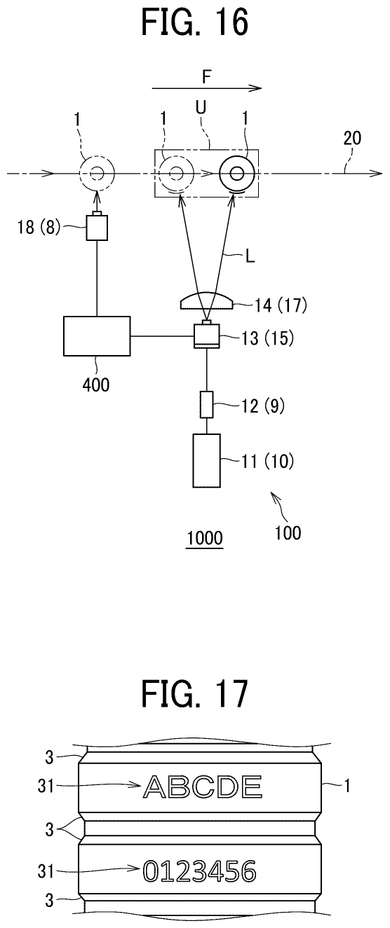

FIG. 16 is a plan view of a laser irradiation system according to the fourth embodiment of the present disclosure.

In the fourth embodiment of the present disclosure illustrated in FIG. 16, the laser irradiation apparatus 100 includes an uneven detector 18 that detects the position of an uneven portion on the surface of the container 1. The “uneven portion” indicates a concept including a protrusion, a recess, or both. The uneven detector 18 can be selected as appropriate as long as it can detect the position of the uneven portion on the surface of the container 1. In this case, a camera 8 that captures an image of the surface of the container 1 is used as an example of the uneven detector 18.

The uneven detector 18 is disposed upstream from the laser irradiation area U in the conveyance direction F. Thus, when the container 1 is conveyed along the conveyance path 20, the position of the uneven portion of the container 1 is detected by the uneven detector 18 before the container 1 reaches the laser irradiation area U. The position information of the uneven portion detected by the uneven detector 18 is sent from the uneven detector 18 to the control unit 400. The control unit 400 controls the scanner 13 based on the detection result of the uneven detector 18 to scan the laser irradiation region that does not overlap the uneven portion with the laser beam.

As described above, in the fourth embodiment of the present disclosure, since the scanner scans the irradiation region so as not to overlap the uneven portion of the container 1 based on the detection result of the uneven detector 18, the image pattern 31 can be formed with avoiding the uneven portion 3 as illustrated in FIG. 17. Accordingly, a good visibility and discrimination of the image pattern 31 can be obtained.

### Fifth Embodiment

A fifth embodiment of the present disclosure will be described.

When the surface of the container 1 is irradiated with the laser beam, the properties of the surface of the container 1 are changed. Accordingly, fine particles referred to as fume may be generated as dust. If such fine particles are present on the laser irradiation path (i.e., scanning range), the laser beam is diffusely reflected by the fine particles. As a result, the desired laser energy does not reach the surface of the container, and processing defects may occur. Thus, it is preferable that the fine particles are moved from the laser irradiation path (i.e., scanning range) using an airflow generator such as a fan.

In the fifth embodiment according to the present disclosure, when multiple irradiation regions 21a to 21d arranged in the longitudinal direction are irradiated with laser beams as illustrated in FIG. 11, the order in which the multiple irradiation regions 21a to 21d are irradiated with laser beams and the direction of the airflow are set as follows.

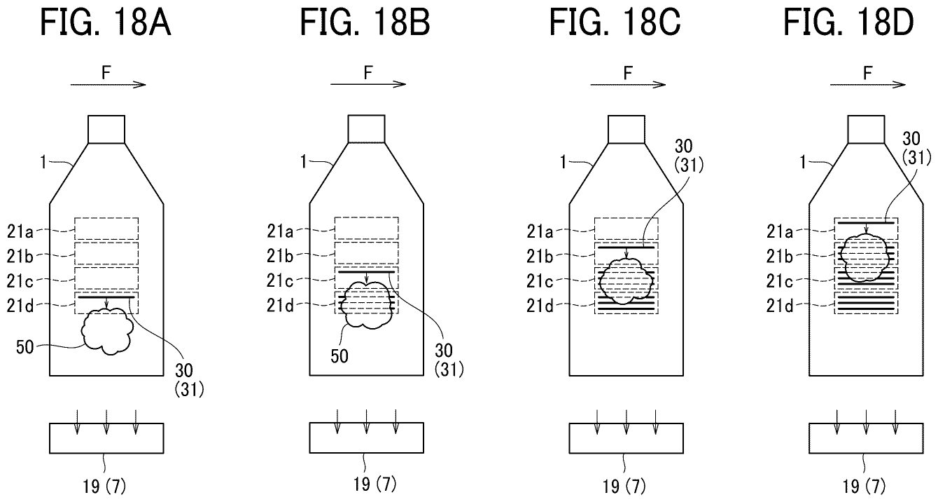

FIGS. 18A to 18D are diagrams illustrating the order in which the irradiation regions 21a to 21d are irradiated with laser beams and the direction of airflow generation in multiple irradiation regions 21a to 21d in the fifth embodiment according to the present disclosure.

The laser irradiation apparatus 100 according to the fifth embodiment of the present disclosure includes an airflow generator 19 that generates airflow. In this embodiment, an air intake device 7 is used as the airflow generator 19, but the airflow generator 19 may be a blower such as a fan or a circulator in addition to the air intake device 7.

The air intake device 7 is disposed below the container 1 to be conveyed. Thus, when the surrounding air is taken by the air intake device 7, airflow is generated along the surface of the container 1 (while contacting the surface) from the upper side to the lower side. Further, it is preferable that a part of the air intake port of the air intake device 7 is disposed so as to overlap the container 1 (i.e., so as to be disposed at the inside of the surface of the container 1) as viewed from above the container 1 such that the airflow is generated along the surface of the container 1.

The irradiation region is scanned with the laser beam from the lowest irradiation region 21d. Accordingly, when the container 1 reaches the first laser irradiation area, the lowest irradiation region 21d is first irradiated with the laser beam as illustrated in FIG. 18A, and the image pattern 31 (image line 30) is formed. At this time, although the dust 50 containing fine particles is generated by the laser irradiation, the dust 50 moves downward because the airflow is generated on the surface of the container 1 from the upper side to the lower side by the air intake device 7. Accordingly, since the dust 50 is prevented from moving to the upper side, in the case where the irradiation region 21c located next to and above the irradiation region 21d (in the case of FIG. 18B) is irradiated with the laser beam, the laser irradiation can avoid the influence of the dust 50.

When the irradiation region 21c located next to above the irradiation region 21d is irradiated with the laser beam, the dust 50 is also generated. However, in this case, since the dust 50 moves to the lower side by the suction of the air intake device 7, the laser irradiation can avoid the influence of the dust 50 even when the irradiation region 21c (in the case of FIG. 18C) is irradiated with the laser beam. Similarly, also in the irradiation regions 21b and 21a to be irradiated with the laser beam after the irradiation of the irradiation region 21c, the generated dust 50 moves to the lower side. As a result, the laser irradiation can avoid the influence of the dust 50.

As described above, in the fifth embodiment according to the present disclosure, the laser irradiation starts from the lowest irradiation region 21d, and the airflow is generated from the upper side to the lower side. As a result, the laser irradiation can avoid the influence of the dust 50, and a good image pattern can be formed.

The order in which the irradiation regions are irradiated with laser beams may not be from the lowest irradiation region 21d, but may be from the highest irradiation region 21a. In this case, the direction of the airflow is set to be opposite, that is, from the lower side to the upper side. As a result, the laser irradiation can avoid the influence of the dust 50 generated in the upper irradiation region to the lower irradiation region. Accordingly, the direction of the airflow may be changed in accordance with the order in which irradiation regions are irradiated with laser beams. However, since the particles contained in the dust 50 have mass even if they are fine, it is effective to generate the airflow to the lower side along the gravity direction in terms of promoting the movement of the dust 50. Thus, in order to avoid the influence of the dust 50 more effectively, as in the fifth embodiment, it is preferable to sequentially irradiate the irradiation region from the lowest irradiation region 21d with the laser beam and generate the airflow to the lower side.

Relation between Deviation Amount of Laser Irradiation Position in Optical Axis Direction and Depth of Focus

The relation between the deviation amount D of the laser irradiation position on the container in the optical axis direction and the depth of field (DoF) of the laser beam when the container is conveyed along a curved conveyance path will be described.

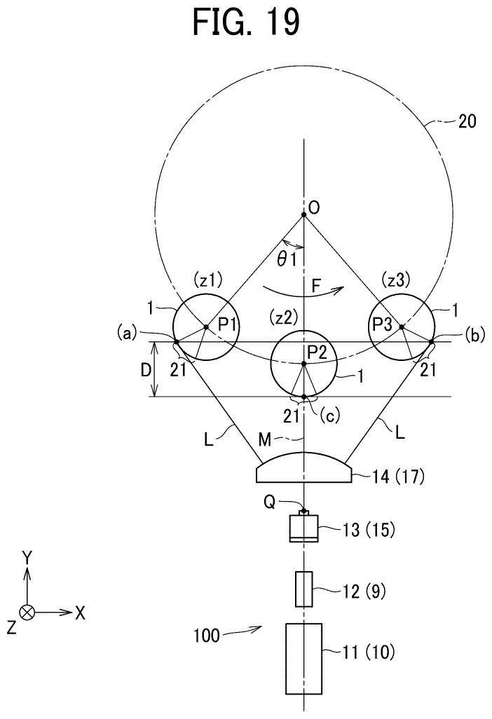

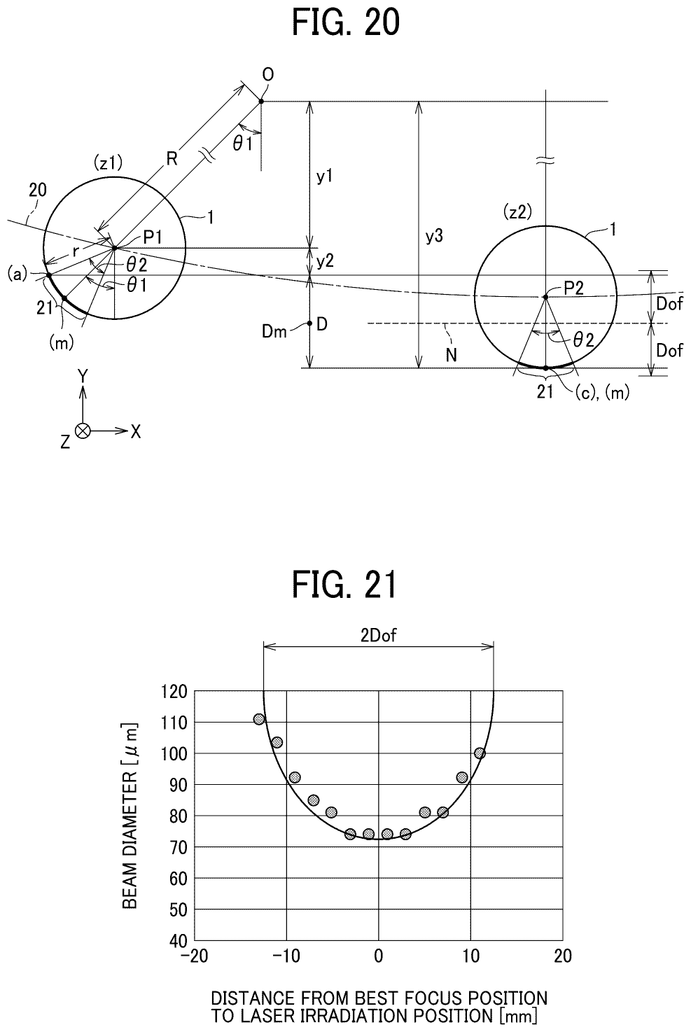

FIG. 19 is a plan view of a conveyance path 20 having a circular shape as viewed from a direction perpendicular to a plane including the conveyance path circle. FIG. 20 is a plan view of a container on a part of the circular conveyance path 20 in FIG. 19.

As illustrated in FIG. 19, when the container 1 is conveyed along the conveyance path 20 having a circular shape from the left to the right in the drawing, laser irradiation to the container 1 is started at an irradiation start position (21) on the conveyance path 20. The container 1 passes through an intermediate position (22) on the conveyance path 20, and the laser irradiation to the container 1 is completed at the irradiation end position (23) on the conveyance path 20. At this time, the container 1 is conveyed from the irradiation start position (21) at which laser irradiation starts to the intermediate position (22) of the laser irradiation area U so as to approach the laser irradiation apparatus 100, and conveyed from the intermediate position (22) to the irradiation end position (23) at which laser irradiation ends so as to move away from the laser irradiation apparatus 100. In FIG. 19, a point (a) on the container 1 is a laser irradiation start point on the container 1 at the irradiation start position (21), and a point (b) is a laser irradiation end point on the container 1 at the irradiation end position (23).

In the case where the direction of a straight line passing through the center O of the conveyance path circle along the conveyance path 20 and a front position (c) of the container 1 when the container 1 most approaches a laser emission reference point Q (in this case, when the container 1 is closest to the laser emission point of the second galvano mirror 16) is defined as the “Y-axis direction”, the laser irradiation position on the container 1 is displaced by the distance D in the Y-axis direction in FIG. 19 with the movement of the container 1. In other words, when the container 1 is conveyed along the conveyance path 20 having a circular shape, the laser irradiation position on the container 1 changes by the distance D in the Y-axis direction between the irradiation start position (21) and the irradiation end position (23). On the other hand, the laser irradiation apparatus 100 has an effective focus range in which an object can be effectively irradiated with the laser beam.

FIG. 21 is a graph of the relation between the distance from a best focus position in a focus range to a laser irradiation position and the beam diameter of a laser beam.

Typically, a relation between a beam diameter in the case where the laser beam is focused by the lens and a distance from a best focus position to the laser irradiation position is expressed by a parabolic shape. As illustrated in FIG. 21, when the distance from the best focus position to the laser focus position increases in the positive direction or the negative direction, the beam diameter gradually increases, which is disadvantageous in performing laser irradiation with high accuracy. Accordingly, in order to perform laser irradiation with high accuracy, it is preferable that the displacement amount D of the laser irradiation position in the Y-axis direction is within the effective focus range (2 DoF).

In FIG. 19, the angle P1-O-P2 is defined as θ1, where P1 is the center position of the container 1 when laser irradiation is started on the container 1, O is the center position of the conveyance path circle, and P2 is the center position of the container 1 when the container 1 is closest to approaches the laser emission reference point Q. In FIG. 20, when the center angle of the arc region (i.e., irradiation region 21) irradiated with the laser beam on the surface of the container 1 is defined as θ2, the radius of the conveyance path circle is R, and the radius of the cylindrical surface of the container 1 is r, the distances y1, y2, and y3 in the Y-axis direction in FIG. 20 are expressed by the following expressions (3), (4), and (5). The distance y1 is the distance in the Y-axis direction between the center O of the conveyance path circle and the center P1 of the container 1 at the irradiation start position (z1). The distance y2 is the distance in the Y-axis direction between the center P1 of the container 1 at the irradiation start position (z1) and the laser irradiation start point (a) on the container 1 at the irradiation start position (z1). The distance y3 is the distance in the Y-axis direction between the center O of the conveyance path circle and the front position (c) of the container 1 when the container 1 is closest to the laser emission reference point Q (intermediate position (z2)).

$$y 1 = R \cdot cos θ 1 \qquad Expression ( 3 )$$

$$y 2 = r \cdot cos ( θ 1 + θ 2 / 2 ) \qquad Expression ( 4 )$$

$$y 3 = R + r \qquad Expression ( 5 )$$

Using the above expressions (3), (4) and (5), the displacement amount D of the laser irradiation position in the Y-axis direction is expressed as the following expression (6).

$$D = R ( 1 - cos θ ) + r ( 1 - cos ( θ 1 + θ 2 / 2 ) ) \qquad Expression ( 6 )$$

In this case, since the container 1 moves on a symmetric path from the irradiation start position (z1) to the irradiation end position (z3) with the intermediate position (22) when the container 1 is closest to the laser emission reference point Q interposed therebetween, the displacement amount D of the laser irradiation position in the Y-axis direction from the irradiation start position (21) to the intermediate position (22) is the same as the displacement amount D of the laser irradiation position in the Y-axis direction from the intermediate position (22) to the irradiation end position (23). Accordingly, in FIG. 20, the distance between the irradiation start position (21) and the intermediate position (22) in the Y-axis direction is defined as the displacement amount D of the laser irradiation position in the Y-axis direction.

Further, when the maximum distance from the best focus position N of the laser beam illustrated in FIG. 20 to the effective focus position is the DoF, the effective focus range can be expressed as 2DoF that is twice the DoF. Thus, in order to perform laser irradiation with high accuracy, it is preferable that the relation of the following expression (7) is satisfied such that the displacement amount D of the laser irradiation position in the Y-axis direction is within the effective focal range (2DoF). The best focus position N is located at the center O side of the conveyance path circle with respect to the front position (c) of the container 1 when the container 1 is closest to the laser emission reference point Q.

$$D = R ( 1 - cos θ ) + r ( 1 - cos ( θ 1 + θ 2 / 2 ) ) < 2 \times Dof \qquad Expression ( 7 )$$

As described above, various parameters are set such that the displacement amount D of the laser irradiation position in the Y-axis direction is within the effective focal range (2DoF). Accordingly, the laser irradiation accuracy is increased.

The parameters used in the laser processing are defined by the specifications and configurations of the laser irradiation apparatus to be used and the diameter of the beam spot at the time of the processing from the following expressions (8) and (9). A pulse width represents a time during which an object is irradiated with one pulse of the laser beam. In the nanosecond order, processing by thermal denaturation corresponding to the absorption spectrum of the object is performed, and in the sub-picosecond order, in addition to thermal denaturation, a phenomenon referred to as multiphoton absorption occurs. In the multiphoton absorption, the state of electrons and atoms are transited to a high energy level due to the simultaneous absorption of multiple photons due to absorption at ½ to ⅓ wavelengths of the laser wavelength. Thus, the solid material is sublimated without passing through a molten state, and a processing mark can be obtained.

$$P = E \cdot v , \qquad Expression ( 8 )$$

where P is the average output (watt (W)) of the pulse laser, E is the pulse energy (joule (J)), and v is the repetition frequency (hertz (Hz)) of the pulse laser.

$$F = E / S , \qquad Expression ( 9 )$$

where, F (Joule (J)/square centimeter (cm²)) is the fluence, and S (cm²) is the area of the laser beam spot.

An energy E per pulse is a value obtained by dividing an average output P by a repetition frequency v, and a fluence F is a value obtained by dividing the energy E by a beam spot area S.

In the embodiment according to the present disclosure, the processing accuracy by laser irradiation was evaluated under the conditions of 50 W and 1000 kilohertz (kHz) and the fθ lens focus distance of f580 using an IceFyre 355-50 (wavelength is 355 nm, pulse width is 10 picoseconds (ps) manufactured by Spectra-Physics. As a result, the processing quality by laser irradiation was good from the best focus position to the DoF of 12 mm at the beam waist diameter of 73 μm.

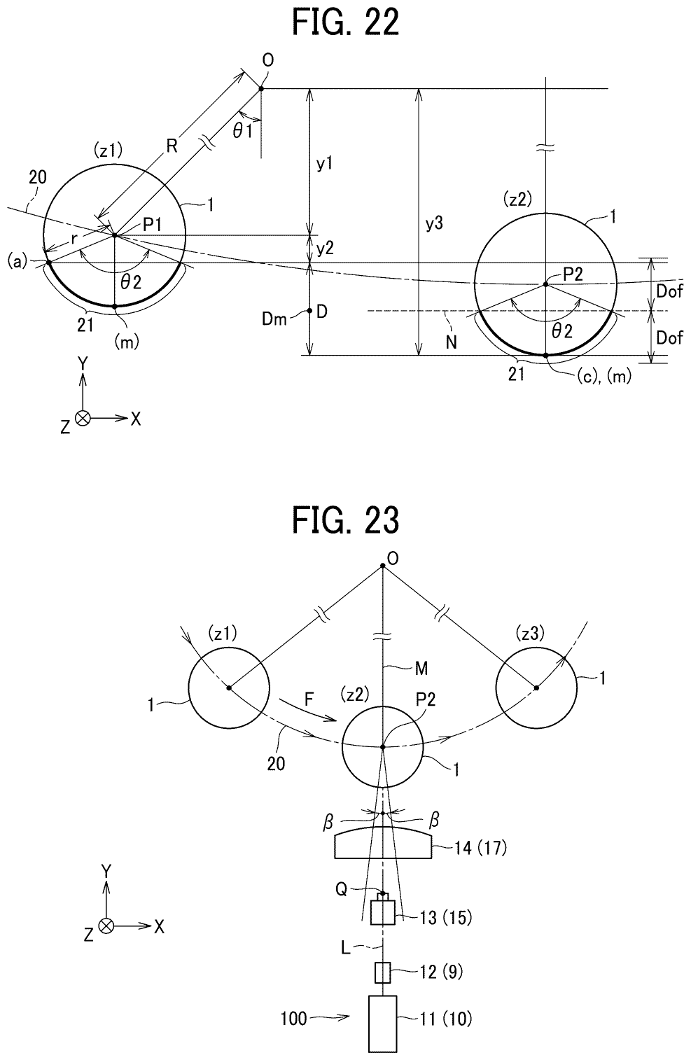

FIG. 22 is a plan view of another aspect of conveyance of a container conveyed along the conveyance path 20 having a circular shape.

The example illustrated in FIG. 22 is different from the examples illustrated in FIGS. 19 and 20 in that the container 1 is conveyed such that the intermediate position (m) in the width direction in the irradiation region 21 always directly faces a plane perpendicular to the laser beam axis (Y-axis direction). In other words, in FIGS. 19 and 20, the container 1 is conveyed such that the intermediate position (m) in the width direction in irradiation region 21 faces outward in the radius direction of the conveyance path circle, but in FIG. 22, the container 1 is conveyed such that the intermediate position (m) of the width direction in the irradiation region 21 always directly faces a plane perpendicular to the laser beam axis while the container 1 is rotating. Other aspects are the same as those in the examples of FIGS. 19 and 20.

In this case, the distances y1, y2, and y3 in the Y-axis direction in FIG. 22 are expressed by the following expressions (10), (12), and (12). The distances y1, y2, and y3, and the values of θ1, θ2, r, and R in the expressions (10) to (12) are same as the distances y1, y2, and y3 and the values θ1, θ2, r, and R in FIG. 20 and in the expressions (3), (4), and (5).

$$y 1 = R \cdot cos θ 1 \qquad Expression ( 10 )$$

$$y 2 = r \cdot cos ( θ 2 / 2 ) \qquad Expression ( 11 )$$

$$y 3 = R + r \qquad Expression ( 12 )$$

Using the above expressions (10), (11) and (12), the displacement amount D of the laser irradiation position in the Y-axis direction is expressed as the following expression (13).

$$D = R ( 1 - cos θ 1 ) + r ( 1 - cos ( θ 2 / 2 ) ) \qquad Expression ( 13 )$$

Thus, in this case as well, in order to perform laser irradiation with high accuracy, it is preferable that the relation of the following expression (14) is satisfied such that the displacement amount D of the laser irradiation position in the Y-axis direction is within the effective focal range (2DoF). As a result, the laser irradiation accuracy can be increased.

$$D = R ( 1 - cos θ 1 ) + r ( 1 - cos ( θ 2 / 2 ) ) < 2 \times Dof \qquad Expression ( 14 )$$

In the example illustrated in FIG. 20 or 21, it is preferable that the intermediate position Dm in the Y-axis direction between the laser irradiation start point (a) on the container 1 at the irradiation start position (z1) and the front position (c) of the container 1 when the container 1 is closest to the laser emission reference point Q (i.e., intermediate position (z2)) is the best focus position N. Thus, when the container 1 is conveyed along the conveyance path 20 having the circular shape, the irradiation region 21 of the container 1 is easily included in the effective focal range (2DoF). As a result, the laser irradiation accuracy can be increased.

The relation between the deviation amount of the laser irradiation position in the optical axis direction (displacement amount D of the laser irradiation position) and the DoF as described above is not limited to the case where the container 1 is conveyed along the conveyance path 20 having the circular shape, and is applicable to the case where the container 1 is conveyed along a conveyance path 20 having a shape other than the circular shape.

### Laser Emission Reference Position

FIG. 23 is a diagram illustrating a preferable laser emission reference position. As illustrated in FIG. 23, when the conveyance path 20 is viewed in a direction perpendicular to a plane including the conveyance path circle, the laser emission reference point Q is preferably disposed on a straight line M passing through the center O of the conveyance path circle and the center position P2 of the container 1 when the container 1 is closest to the laser emission reference point Q. As described above, since the laser emission reference point Q is disposed on the straight line M, the laser irradiation can be performed with high accuracy in a short time over a wide range in the conveyance direction F.

The laser emission reference point Q is not necessarily arranged on the straight line M, but may be arranged at a position displaced from the straight line M. However, in order to increase the laser irradiation accuracy, it is preferable that a deviation amount β of the laser emission reference point Q from the straight line M illustrated in FIG. 23 is less than ±5°. The deviation amount β of the laser emission reference point Q is a deviation amount in the circumferential direction with respect to the center position P2 of the container 1 when the container 1 is closest to the laser emission reference point Q with respect to the straight line M. As described above, the laser emission reference point Q is arranged within a range less than ±5° in the circumferential direction around the center position P2 of the container 1 when the center position P2 of the container 1 is closest to the laser emission reference point Q of the container 1 based on the straight line M. As a result, the laser irradiation accuracy can be increased.

### Characteristics of Image Pattern (Modified Portion) Formed by Present Disclosure

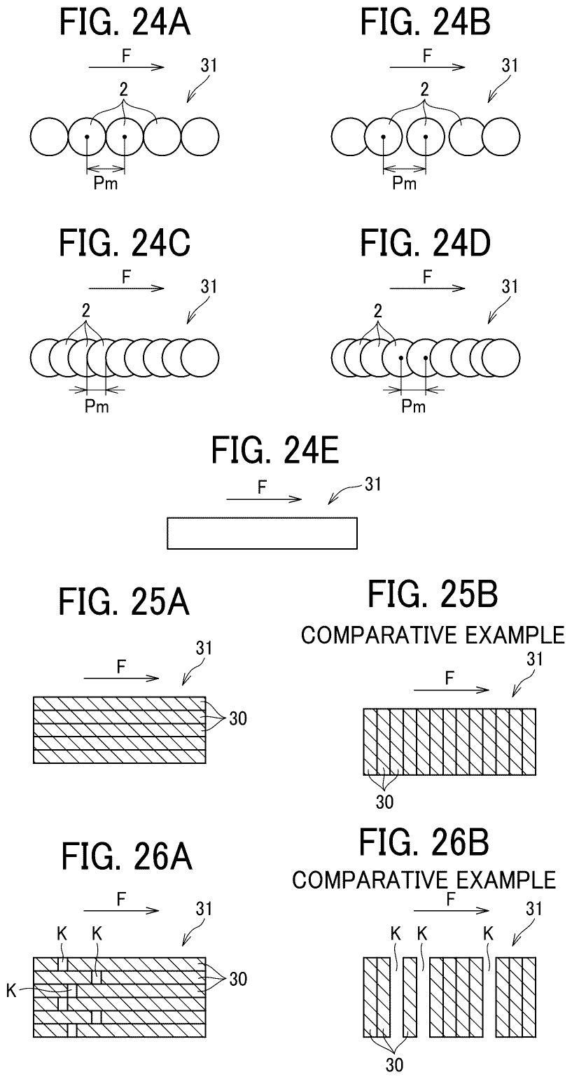

FIGS. 24A to 24E are diagrams illustrating examples of image patterns formed in an embodiment according of the present disclosure.

In the present embodiment, since the laser irradiation apparatus scans the laser irradiation region of the container with the laser beam in the main scanning direction along the conveyance direction F, an image pattern 31 in which multiple modified portions 2 are arranged in the conveyance direction F is formed as illustrated in FIGS. 24A to 24D. When a CW laser oscillator is used as the laser oscillator, a linear image pattern 31 continuously extending in the conveyance direction F as illustrated in FIG. 24E is formed.

In the case where the laser oscillator is a pulsed laser oscillator, since the laser irradiation apparatus irradiates the container with the laser beam at a predetermined frequency while scanning in the conveyance direction F, the interval Pm between the multiple modified portions 2 arranged in the conveyance direction F are basically equal as illustrated in FIG. 24A or FIG. 24C. However, when vibration of the container or the speed fluctuation occurs during conveyance, the laser irradiation may be affected by the vibration or the speed fluctuation, and the interval Pm between the adjacent modified portions 2 may vary as illustrated in FIG. 24B or 24D. However, in the case of the present disclosure, as described above, the variation in the interval Pm between the modified portions 2 can be decreased as compared with the comparative example in which the irradiation region is scanned with the laser beam in the direction intersecting the conveyance direction F

FIG. 25A is a diagram illustrating an image pattern formed in an embodiment of the present disclosure, and FIG. 25B is a diagram illustrating an image pattern formed in a comparative example.

As illustrated in FIG. 25A, in the present embodiment, since laser scanning in the direction along the conveyance direction F (i.e., main scanning direction) is repeatedly performed in the direction intersecting the conveyance direction F (i.e., sub-scanning direction), multiple image lines 30 extending in the conveyance direction F are formed so as to be arranged in the direction intersecting the conveyance direction F.

In contrast, in the comparative example illustrated FIG. 25B, since the laser scanning in the direction intersecting the conveyance direction F is repeatedly performed in the conveyance direction F, multiple image lines 30 extending in the direction intersecting the conveyance direction F are formed so as to be arranged in the conveyance direction F.

In an embodiment of the present disclosure, when the image lines 30 as illustrated in FIG. 25A are formed, if vibration or speed fluctuation occurs in the conveyance direction F, as illustrated in FIG. 26A, a portion K at which the interval Pm between the modified portions 2 increases due to vibration or speed fluctuation occurs for each image line 30. In this case, since the timing at which vibration or speed fluctuation occurs is generally different for each image line 30, the position of the portion K at which the interval Pm between the modified portions 2 is larger is also basically different for each image line 30.

In contrast, in the comparative example illustrated in FIG. 26B, since the multiple image lines 30 extending in the direction intersecting the conveyance direction F are formed so as to be arranged, if the vibration or speed fluctuation occurs in the conveyance direction F, a portion K at which the interval between the image lines increases is generated as illustrated in FIG. 26B. In this case, the portion K having a larger interval is intermittently generated in the direction intersecting the conveyance direction F.

As described above, an embodiment of the present disclosure and the comparative example are different in the position of the portion at which the interval between the modified portions increases due to vibration or speed fluctuation and the aspect in which the portion occurs. In particular, in the case of an embodiment according to the present disclosure, as compared with the comparative example, the position of the portion K at which the interval increases tends to vary for each image line 30 in the conveyance direction F. Thus, it can be determined whether the image pattern formed by the present disclosure or the image pattern formed by the comparative example based on the position of the portion at which the interval between the modified portions increases and the aspect in which the portion occurs as described below.

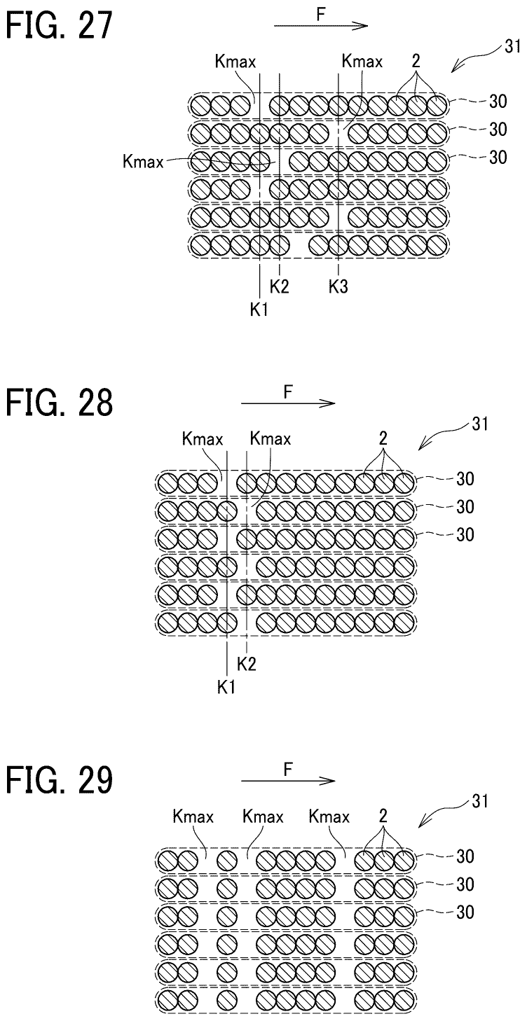

For example, in the image pattern 31 formed by the present embodiment as illustrated in FIG. 27, when a portion at which the interval between adjacent modified portions 2 at each image line 30 is the largest is referred to as a maximum interval portion Kmax, the number of combinations of the image lines 30 in which the positions of the maximum interval portions Kmax (i.e., maximum interval positions) are different from each other is likely to be more than half of the number of all the image lines 30.

As illustrated in FIG. 27, when six image lines 30 extending in the conveyance direction F (i.e., main scanning direction) are arranged in a direction intersecting the conveyance direction F (i.e., sub-scanning direction), the maximum interval positions different from each other are three positions, that is, K1, K2, and K3 in the conveyance direction F, and the number of combinations of the image lines 30 having different maximum interval positions is three, that is, K1-K2, K2-K3, and K1-K3. In this case, since the number of all image lines 30 is six, the number of combinations (i.e., three) of the image lines 30 having different maximum interval positions is equal to or larger than half of the number (i.e., six) of all image lines 30.

In contrast, in the case where the number of combinations of the image lines having different maximum interval position is only one, that is, K1-K2, the number of combinations (i.e., one) of the image lines 30 having different maximum interval positions is equal to or larger than half of the number of all image lines 30 (i.e., six).

In addition, as in the comparative example of FIG. 26B, when the portions K having a larger interval are continuously generated in the direction intersecting the conveyance direction F, as illustrated in FIG. 29, if the image lines are extending in the conveyance direction F, the maximum interval positions of the image lines 30 are the same as each other. In this case, since the number of combinations of the image lines 30 having different maximum interval positions in the conveyance direction F is 0, the number of combinations of the image lines 30 having different maximum interval positions (i.e., 0) is not equal to or larger than half of the number of all the image lines 30 (i.e., 6) in the comparative example.

Accordingly, it can be determined whether the image pattern is the image pattern obtained according to the present disclosure or the image pattern obtained according to the comparative example by checking whether the number of combinations of the image lines 30 having different maximum interval positions is equal to or larger than half of the number of all the image lines 30.

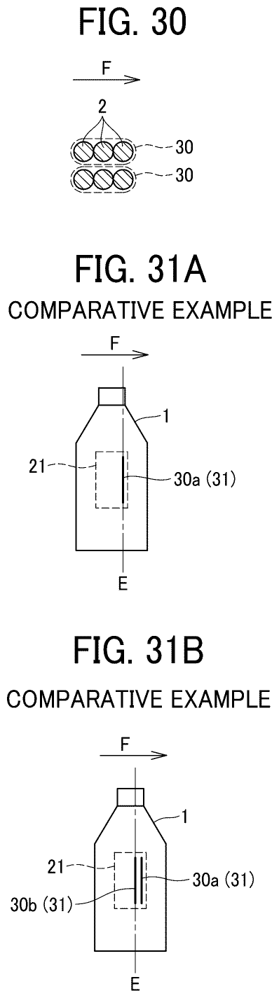

In FIG. 27, the number of image lines 30 extending in the conveyance direction F is six, but the determination method is not limited to the case where the number of image lines 30 is six. It can be determined whether the image pattern is the image pattern obtained according to the present disclosure as long as the image pattern has a region at which at least three or more image lines 30 in which the modified portions 2 are continuously arranged in the conveyance direction F are formed in two or more rows in a direction intersecting the conveyance direction F as illustrated in FIG. 30.

As described above, aspects of the present disclosure are, for example, as follows.

### First Aspect

A laser irradiation apparatus to irradiate an irradiation region of an object conveyed includes a laser oscillator to oscillate a laser beam and a scanner to two-dimensionally scan the irradiation region of the object with the laser beam in scanning directions intersecting each other. In the scanning directions intersecting each other, a direction having a longer scanning length in a single scan is a main scanning direction, and another direction intersecting the direction is a sub-scanning direction. The scanner scans an irradiation region having a larger size in the main scanning direction than the sub-scanning direction in the main scanning direction so as to be along the conveyance direction.

### Second Aspect

In the laser irradiation apparatus according to the first aspect, the scanner includes multiple scanners each to scan the different laser irradiation regions with the laser beam. Each of the multiple scanner scan an irradiation regions having a larger size in the main scanning direction than the sub-scanning direction in the main scanning direction so as to be along the conveyance direction.

### Third Aspect

The laser irradiation apparatus according to the first or second aspect, further includes an uneven detector to detect an uneven including a protrusion or a recess on the surface of the object. The scanner scans the irradiation region so as not to overlap the protrusion or the recess based on the result from the uneven detector.

### Fourth Aspect

The laser irradiation apparatus according to any one of the first to third aspects, further includes an airflow generator to generate airflow on the surface of the object. The scanner scans multiple irradiation region arranged in longitudinal direction on the surface of the object in order. The airflow generator changes the direction of the airflow depending on the order of the laser irradiation to the multiple irradiation region.

### Fifth Aspect

In the laser irradiation apparatus according to the fourth aspect, the scanner scans the laser irradiation regions with the laser beam from the lowest irradiation region in order, and the airflow generator generate the airflow from the upper side to the lower side.

### Sixth Aspect

The laser irradiation apparatus according to any one of the first to fifth aspects irradiates the cylindrical surface of the object conveyed along the curved conveyance path with the laser beam. A following expression is satisfied: R(1−cos θ1)+r(1−cos(θ2−θ1)) <2×DoF, where θ1 is an angle formed by P1-O-P2, where P1 is a center position of the object at which the laser irradiation starts to the object, O is a center of the conveyance path circle along the curved conveyance path, P2 is a center position of the object when the object is closest to a laser emission reference point, θ2 is a center angle of an arc region with which the laser beam is irradiated in the surface of the object, R is a radius of the conveyance path circle, r is a radius of the cylindrical surface of the object, and DoF is a depth of field of the laser beam, and the best focus position of the laser beam is at a side of the center of the conveyance path circle rather than a front position of the object when the object is closest to the laser emission reference point.

### Seventh Aspect

In the laser irradiation apparatus according to any one of the first to fifth aspects, the object is conveyed such that an intermediate position in the width direction of the arc region with which the laser beam is irradiated in the cylindrical surface of the object directly faces a plane perpendicular to the laser beam axis, and the laser irradiation apparatus irradiates the surface of the object with the laser beam to form an image pattern. A following expression is satisfied: R(1−cos θ1)+r(1−cos(θ2/2))<2×DoF, where θ1 is an angle formed by P1-O-P2, where P1 is a center position of the object at which the laser irradiation starts to the object, O is a center position of the conveyance path circle along the curved conveyance path, P2 is a center position of the object when the object is closest to a laser emission reference point, θ2 is a center angle of an arc region with which the laser beam is irradiated in the surface of the object, R is a radius of the conveyance path circle, r is a radius of the cylindrical surface of the object, and DoF is a depth of field of the laser beam, and the best focus position of the laser beam is at a side of the curved conveyance path circle rather than a front position of the object when the object is closest to the laser emission reference point.

### Eighth Aspect

The laser irradiation apparatus according to any one of the first to seventh aspects irradiates the surface of the object conveyed along the curved conveyance path with the laser beam. As viewed from the direction perpendicular to a plane including a conveyance path circle along the curved conveyance path, the Y-axis direction is defined by a direction of a straight line passing through the center of the conveyance path circle and a front position when the object is closest to the laser emission reference point. The best focus position is an intermediate position between a laser irradiation start point to the object when the laser irradiation to the object starts and the front position of the object when the object most approaches the laser emission reference point in the Y-axis direction.

### Ninth Aspect

The laser irradiation apparatus according to any one of the first to eighth aspects irradiates the surface of the object conveyed along the curved conveyance path with the laser beam. As viewed from a direction perpendicular to a plane including a conveyance path circle along the curved conveyance path, the laser emission reference point is disposed on the straight line passing through the center position of the object when the object is closest to the laser emission reference point and the center of the conveyance path circle.

### Tenth Aspect

The laser irradiation apparatus according to any one of the first to ninth irradiates the surface of the object conveyed along the curved conveyance path with the laser beam. As viewed from a direction perpendicular to a plane including a conveyance path circle along the curved conveyance path, based on a straight line passing through a center position of the object when the object is closes to the laser emission point and the center of the conveyance path circle, the laser emission reference point is arranged within a range less than ±5° in the circumferential direction with respect to the center of the object when the object is closest to approaches the laser emission reference point.

### Eleventh Aspect

In a laser irradiation method to irradiate an irradiation region of an object conveyed with a laser beam, the surface of the object is two-dimensionally scanned with the laser beam in scanning directions intersecting each other. A scanning direction having a longer scanning length in a single scanning is a main scanning direction, and another scanning direction intersecting the main scanning direction is a sub-scanning direction. The laser irradiation method scans an irradiation region having a larger size in the main scanning direction than the sub-scanning direction in the main scanning direction so as to be along the conveyance direction.

### Twelfth Aspect

A laser irradiation system includes a conveyor to convey an object, a laser irradiation apparatus to irradiate the surface of the object conveyed with the laser beam to form an image patter. The laser irradiation apparatus includes a laser oscillator to oscillate a laser beam and a scanner to two-dimensionally scan the irradiation region of the object with the laser beam in scanning directions intersecting each other. In the scanning directions intersecting each other, a direction having a longer scanning length in a single scan is a main scanning direction, and another direction intersecting the direction is a sub-scanning direction. The scanner scans an irradiation region having a larger size in the main scanning direction than the sub-scanning direction in the main scanning direction so as to be along the conveyance direction.

### Thirteenth Aspect

An object includes modified portions formed by the laser irradiation method according to the eleventh aspect. The modified portions are formed on the surface of the object while the object conveys and aligned in the conveyance direction of the object in a row.

### Fourteenth Aspect

In the object according to the thirteenth aspect, two or more of image lines including at least three or more of the modified portions in a row in the conveyance direction are formed in a direction intersecting the conveyance direction of the object. Maximum interval portions having a maximum interval between adjacent modified portions in each of the image lines occur, and a number of combination of the image lines having positions of the maximum interval portions different from each other is equal to or less than a half.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

1. A laser irradiation apparatus comprising:
a laser oscillator to: oscillate a laser beam; and irradiate, with the laser beam, an irradiation region of an object conveyed in a conveyance direction; and
a scanner to scan the irradiation region with the laser beam: in a main scanning direction along the conveyance direction; and in a sub-scanning direction intersecting the main scanning direction,
wherein the scanner scans, with the laser beam, the irradiation region having: a first size in the main scanning direction; and a second size smaller than the first size in the sub-scanning direction.

2. The laser irradiation apparatus according to claim 1, further comprising multiple scanners including the scanner to respectively scan multiple irradiation regions including the irradiation region with laser beams, and
the multiple scanners scan, with the laser beams, the multiple irradiation regions each having:
a first size in the main scanning direction; and
a second size smaller than the first size in the sub-scanning direction.

3. The laser irradiation apparatus according to claim 1, further comprising a detector to detect a position of an uneven portion of the object,
the object having a protrusion or a recess on a surface of the object, and the uneven portion having a portion that changes from the protrusion to the recess or from the recess to the protrusion,
wherein the scanner scans the irradiation region other than the uneven portion with the laser beam based on a detection of the detector.

4. The laser irradiation apparatus according to claim 1, further comprising:
an airflow generator to generate airflow on a surface of the object in the sub-scanning direction intersecting the conveyance direction,
wherein the scanner scans multiple irradiation regions including the irradiation region with the laser beam in an order of laser irradiation,
the multiple irradiation regions are arranged in the sub-scanning direction, and
the airflow generator changes a direction of the airflow according to the order of laser irradiation.

5. The laser irradiation apparatus according to claim 4,
wherein the scanner scans the multiple irradiation regions with the laser beam from a lowest irradiation region of the multiple irradiation regions in the order of laser irradiation, and
the airflow generator generates the airflow in the sub-scanning direction from a highest irradiation region to the lowest irradiation region.

6. The laser irradiation apparatus according to claim 1, further comprising
a conveyor to convey the object having a cylindrical surface in a curved conveyance path having a conveyance path circle,
wherein a following expression is satisfied,
$$R ( 1 - cos θ 1 ) + r ( 1 - cos ( θ 1 + θ 2 / 2 ) ) < 2 \times DoF ,$$
where θ1 is an angle formed by P1, O, and P2,
where P1 is a center position of the object,
O is a center position of the conveyance path circle along the curved conveyance path, and
P2 is a center position of the object when the object is closest to a laser emission reference point,
θ2 is a center angle in a range of an arc of the cylindrical surface of the object irradiated with the laser beam,
R is a radius of the conveyance path circle,
r is a radius of a surface of the object having the cylindrical surface,
DoF is a depth of field of the laser beam, and
a best focus position is closer to the center position of the conveyance path circle than a front position of the object at a position closest to the laser emission reference point.

7. The laser irradiation apparatus according to claim 1, further comprising a conveyor to convey the object having a cylindrical surface in a curved conveyance path having a conveyance path circle, an intermediate position in a width direction of an arc region of the cylindrical surface irradiated with the laser beam directly facing a plane perpendicular to an optical axis of the laser beam,
wherein a following expression is satisfied,
$$R ( 1 - cos θ 1 ) + r ( 1 - cos ( θ 2 / 2 ) < 2 \times DoF ,$$
where θ1 is an angle formed by P1, O, and P2, where
P1 is a center position of the object,
O is a center position of the conveyance path circle along the curved conveyance path, and
P2 is a center position of the object when the object is closest to a laser emission reference point,
θ2 is a center angle in a range of an arc of the cylindrical surface of the object irradiated with the laser beam,
R is a radius of the conveyance path circle,
r is a radius of a surface of the object having the cylindrical surface, and
DoF is a depth of field of the laser beam, and
a best focus position is closer to the center position of the conveyance path circle than a front position of the object at a position closest to the laser emission reference point.

8. The laser irradiation apparatus according to claim 1,
further comprising a conveyor to convey the object in a curved conveyance path having a conveyance path circle, in a plane including the conveyance path circle, and in a direction of a straight line passing through a center of the conveyance path circle and a front position of the object when the object is closest to a laser emission reference point, and a best focus position of laser irradiation is an intermediate position between a laser irradiation start point of the object in the direction of the straight line when the laser irradiation to the object starts and the front position of the object.

9. The laser irradiation apparatus according to claim 8,
wherein the laser emission reference point is disposed in the straight line passing through a center position of the object when the object is closest to the laser emission reference point and the center of the conveyance path circle.

10. The laser irradiation apparatus according to claim 8,
wherein the laser emission reference point is disposed in a region less than ±5° of a circumferential direction of the object at a center position of the object when the object is closest to the laser emission reference point based on the straight line.

11. A laser irradiation method comprising:
oscillating a laser beam;
irradiating, with the laser beam, an irradiation region of an object conveyed in a conveyance direction, the irradiation region having:
a first scanning distance in a main scanning direction along the conveyance direction; and
a second scanning distance in a sub-scanning direction intersecting the main scanning direction, the second scanning distance being shorter than the first scanning distance;
scanning the irradiation region of the object with the laser beam in the main scanning direction; and
scanning the irradiation region of the object with the laser beam in the sub-scanning direction.

12. A laser irradiation system comprising:
a conveyer to convey an object in a conveyance direction; and
a laser irradiation apparatus including:
a laser oscillator to:
oscillate a laser beam;
and irradiate, with the laser beam, an irradiation region of the object conveyed in the conveyance direction; and
a scanner to scan the irradiation region with the laser beam:
in a main scanning direction along the conveyance direction; and
in a sub-scanning direction intersecting the main scanning direction,
wherein the scanner scans, with the laser beam, the irradiation region having: a first size in the main scanning direction; and a second size smaller than the first size in the sub-scanning direction.

13. An object comprising:
modified portions formed by the laser irradiation method according to claim 11,
wherein the modified portions are arranged in the conveyance direction of the object.

14. The object according to claim 13,
wherein two or more of image lines including at least three or more of the modified portions in a row in the conveyance direction are formed in a direction intersecting the conveyance direction of the object,
maximum interval portions having a maximum interval between adjacent modified portions in each of the image lines occur, and
a number of combinations of the image lines having positions of the maximum interval portions different from each other is equal to or less than a half.
